(19) United States
(12) Patent Application Publication
(10) Pub. No.: US 2010/0107225 A1
(43) Pub. Date: Apr. 29, 2010

(54) REMOTE SERVICE ACCESS SYSTEM AND METHOD

(75) Inventors: Ron Spencer, Ottawa (CA); Tom Camps, Stittsville (CA); Chris Burchett, Ottawa (CA); Brad Gagné, Kanata (CA); Rob Madge, Kanata (CA)

Correspondence Address: THE NATH LAW GROUP, 112 South West Street, Alexandria, VA, 22314, US

(73) Assignee: BOLDstreet Inc., Ottawa, Ontario (CA)

(21) Appl. No.: 12/451,909

(22) PCT Filed: Jun. 6, 2008
(86) PCT No.: PCT/CA2008/001060

§ 371 Date: Jan. 7, 2010

Related U.S. Application Data
(60) Provisional application No. 60/942,409, filed on Jun. 6, 2007.

(51) Int. Cl. G06F 21/00; H04L 9/00

(52) U.S. Cl. 726/4; 726/3

(57) ABSTRACT

A wireless service access system and method are disclosed. One aspect of the disclosed system provides a remote device wireless access to one or more services over a communication network, the system comprising a network access module adapted for communicating wirelessly with the remote device and for receiving therefrom identifying data; and a service access module, communicatively linked to the network access module, for authenticating the remote device based on the identifying data and authorizing access to the one or more services thereto via the network access module.

### FIELD OF THE INVENTION

The present invention relates to remote systems and, in particular, to a remote service access system and method.

### BACKGROUND

Wireless devices and systems are currently available for enabling a user of a remote device access to a communication network (e.g. the Internet) via a wireless access point and gateway communicatively linked to this communication network. Current access solutions for the wireless access to such communication networks generally do not allow for much flexibility and control in such access, and/or can be relatively cumbersome for remote device manufacturers, end users and/or remote access service providers.

For example, current authentication and authorization methods with browser-enabled remote devices are generally implemented via a Web interface accessed by the remote device upon initial communication with an access point. Namely, remote devices with sufficient browser support can create accounts, purchase time, and login to the network via this Web interface. In such cases, the authentication process generally provides the same amount of authorization regardless of the remote device and its functionality. Such methods are available to remote devices supporting sufficient browser functionality, however, they are generally quite unfriendly to browser-challenged remote devices, and mostly inaccessible to browserless remote devices.

An alternative to the above solution provides for client-based authentication wherein a special client is embedded in the firmware of a remote device upon manufacture or downloaded and installed by an end user of the remote device, and/or wherein a service provider must cooperate with the remote device manufacturer to achieve device-specific authentication. As stated above, such solutions can be quite cumbersome to the remote device manufacturer, the end user and/or the service provider.

Furthermore, public hotspot access (e.g. traditional wireless access) traditionally works on an all-or-none basis. For example, users connecting to a hotspot have no (or very little) access to the Internet when they first connect, however, once payment for online time is received, the user is logged in and gains full access to the wide-open Internet, with virtually no restriction on where they surf or what applications they can use. Although this traditional approach may be acceptable to the business user with an expense account, such methods are generally expensive to the everyday user as online time is usually priced at a premium. As such, public hotspots, combined with current access methods, fail to bridge the gap between the business user and the casual traveler who isn't backed by a corporate spending account and find the traditional hotspot pricing model to be too expensive. In particular, users are not currently provided with access to only the services and/or applications they wish to use as current access methods and systems allow only for full access privileges, and consequently, access services are priced accordingly.

Technologically, operations of public hotspots are very similar, regardless of the price or services offered. Almost all hotspots support the “Universal Access Method” (UAM), which requires no client or software to be installed, the method being implemented in most cases via a common Web browser. Using the UAM, users will typically connect in the following manner: (1) the user enters the hotspot or “hot zone” which is serviced by wireless (e.g. Wi-Fi) coverage, starts a Wi-Fi enabled remote device, and uses it to scan the neighborhood for available wireless signals; (2) upon detecting a publicly available signal, the user will instruct a wireless connection manager software operating on the remote device to establish a radio connection with the detected network; (3) the user opens a Web browser and, in the event the hotspot is offered free of charge (e.g. wide open coverage), the user will gain full access to all Internet functions; otherwise, (4) the user will be redirected to an intercept page of the hotspot provider's design that provides instructions on how to connect, payment pricing and methods, and access to “free” sites and pages.

In this common system access implementation, users who have not yet logged in (e.g. pre-authentication) are severely restricted by standard firewall settings on the network access gateway which prohibit all Internet traffic attempts by these users. Access to certain Websites or resources which have been pre-approved by the Wireless Internet Service Provider (WISP) may however be implemented via a firewall configuration commonly called a “whitelist” or “walled garden”, which generally provides limited and controlled services to pre-authentication users. Once the user completes the necessary steps on the intercept page to purchase online time, his credentials are authenticated and he is connected to the Internet. At this point, an access list that permits all outgoing traffic to any destination is applied at the firewall (that is to say, no restrictions whatsoever) and the typical hotspot user is authorized to access virtually any resource available on the Internet. Any restrictions on access, are applied globally to all users and/or hotspots, and are usually motivated by reasons of security (e.g. to restrict hotspot users from gaining access to each other's systems) or propriety (e.g. restrict users in public settings access to certain questionable web resources).

Currently, wireless users are not provided with access to only the services and/or applications they wish to use as current access methods and systems allow only for full access privileges, and consequently, access services are priced accordingly. Furthermore, access to such systems via browser-challenged or browserless remote devices is either quite unfriendly, if not impossible.

Therefore, there is a need for a new remote service access system and method that overcomes some of the drawbacks of known systems.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a remote service access system and method. In accordance with an aspect of the present invention, there is provided a system for providing a remote device wireless access to one or more services over a communication network, the system comprising a network access module adapted for communicating wirelessly with the remote device and for receiving therefrom a wireless transmission comprising identifying data, said identifying data comprising remote device identification data automatically embedded within said wireless transmission by the remote device; and a service access module communicatively linked to said network access module for receiving said identifying data therefrom, for authenticating the remote device based on said identifying data and authorizing access to the one or more services thereto via said network access module.

In accordance with another aspect of the present invention, there is provided a system for providing a remote device restricted wireless access to one or more services over a communication network, the system comprising a network access module adapted for communicating wirelessly with the remote device and for receiving therefrom identifying data; and a service access module communicatively linked to said network access module for receiving said identifying data therefrom, for authenticating the remote device and associating a service profile therewith based on said identifying data, and authorizing restricted access to the one or more services thereto via said network access module as defined by said service profile.

In accordance with another aspect of the present invention, there is provided a method for providing a remote device wireless access to one or more services over a communication network, the method comprising: communicating wirelessly with the remote device and receiving therefrom a wireless transmission comprising identifying data, said identifying data comprising remote device identification data automatically embedded within said wireless transmission by the remote device; and authenticating the remote device based on said identifying data and authorizing access to the one or more services thereto.

In accordance with another aspect of the present invention, there is provided a method for providing a remote device restricted wireless access to one or more services over a communication network, the method comprising: communicating wirelessly with the remote device and receiving therefrom identifying data; and authenticating the remote device and associating a service profile therewith based on said identifying data, and authorizing restricted access to the one or more services thereto according to said service profile.

### BRIEF DESCRIPTION OF THE FIGURES

FIG. 1 is a high level diagrammatic representation of a remote service access system, in accordance with embodiments of the present invention;

FIG. 2A is a high level diagrammatic representation of an exemplary remote device, in accordance with embodiments of the present invention.

FIG. 2B is a high level diagrammatic representation of a service access module, in accordance with embodiments of the present invention.

FIG. 2C is a high level diagrammatic representation of a network access module, in accordance with embodiments of the present invention.

FIG. 3 is a flow diagram depicting a method of registering a user and a remote device for access to the system of FIG. 1, in accordance with embodiments of the present invention;

FIG. 4 is a flow diagram depicting a process of identifying, authenticating, and authorizing a user with a browser-based or browser challenged mobile or remote device, in accordance with embodiments of the present invention;

FIG. 5 is a sequence diagram depicting communications between components of the system of FIG. 1, for identifying, authenticating, and authorizing a user with a browser-based or browser challenged mobile or remote device, in accordance with embodiments of the present invention;

FIG. 6 is a flow diagram depicting a process of identifying, authenticating, and authorizing a user with a browserless mobile or remote device, in accordance with embodiments of the present invention;

FIG. 7 is a sequence diagram depicting communications between components of the system of FIG. 1, for identifying, authenticating, and authorizing a user with a browserless mobile or remote device, in accordance with embodiments of the present invention;

FIG. 8 is a flow diagram depicting a method of accessing wireless services using a browser-based remote device, in accordance with embodiments of the present invention;

FIG. 9 is a flow diagram depicting a method of accessing wireless services using a browser-challenged remote device, in accordance with embodiments of the present invention;

FIG. 10 is a flow diagram depicting a method of accessing wireless services using a browserless remote device, in accordance with embodiments of the present invention;

FIG. 11 is an exemplary screen shot depicting a relational database containing sample data of hotspot access networks, user profiles, and device profiles, in accordance with embodiments of the present invention.

FIG. 12 illustrates an example of extracting information from a remote device according to an embodiment of the present invention.

### DETAILED DESCRIPTION OF THE INVENTION

### Definitions

The term “hotspot” is used to define a public access venue, location and/or geographical area in which a wireless access point (WAP) provides wireless network services (e.g. 802.11a/b/g/n based or supported services, WiMax based or supported services, cellular network based or supported services such as via CDMA, HSDPA, GPRS, etc., and other such services) to mobile visitors through a wireless local area network (WLAN), metropolitan area network (MAN), wide area network (WAN), or the like, using, for example but not limited to, Wi-Fi technology or the like. Hotspot locations or venues can include, but are not limited to restaurants, train stations, airports, libraries, coffee shops, bookstores, fuel stations, department stores, supermarkets, universities, schools, and other such locations.

The terms “identification”, “authentication” and “authorization” are used to define the processes implemented prior to providing a remote device access to a given system and/or service. In general, the term “identification” is used to define the process of accessing and analyzing information from a remote device and/or user when there is a request from a network-capable remote device to access a hotspot network or the like; the term “authentication” is generally used to define the process of verifying and/or certifying an identified set of criteria as true prior to allowing access; and the term “authorization” is used to define the process of defining the action(s)/network(s)/service(s) that authenticated users and/or remote devices are entitled to, based on user, device, and service profiles, for example by constraining services provided to particular users and/or remote devices by applying authorization constraints to limit access to selected services, or by allowing selected services based on one or more attributes thereof, for example using an authorization whitelist. Service profiling can also depend on hotspot provider, hotspot location, or other service provider. It will be appreciated that different combinations of the above processes may be implemented by a common processing module and/or different intercommunicating modules, using different numbers of steps, or iterations, and having different levels of redundancy and/or parallel processing to provide a selected level of efficiency and/or accuracy.

Unless defined otherwise, all technical and scientific terms used herein have the same meaning as commonly understood by one of ordinary skill in the art to which this invention belongs.

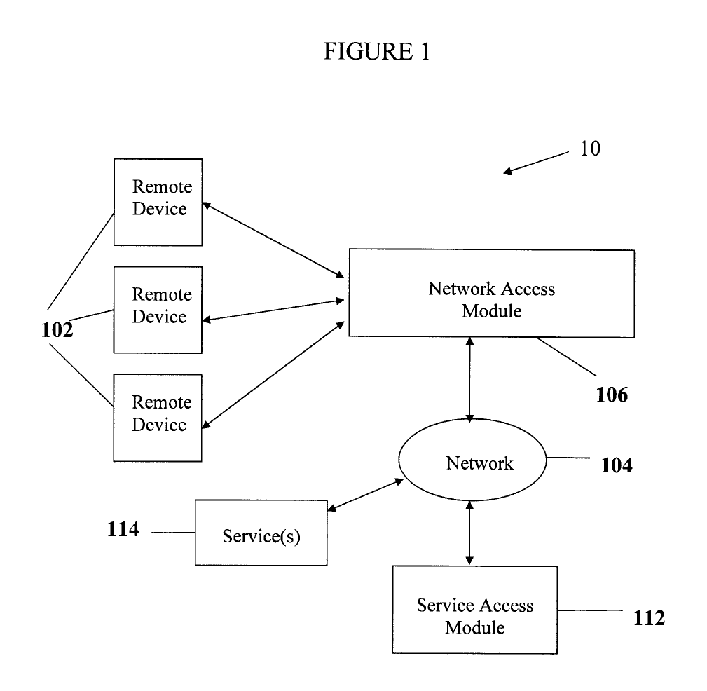

The present invention provides a wireless service access system and method. The system, generally referred to using the numeral 10 and in accordance with embodiments of the present invention, is depicted in FIG. 1 and is configured to provide one or more remote devices 102 access to one or more services 114 via a network 104. In the embodiment depicted in FIG. 1, the system generally comprises one or more network access modules 106, adapted for communicating wirelessly with the one or more remote devices 102, and one or more service access modules as in module 112, communicatively linked to the network access module(s) 106 and configured to provide to the remote device(s) 102 access to the service(s) 114 via the network access module(s) 106 and network 104.

In general, the system 10 may be used to identify different remote devices 102 via the network access module 112, and authenticate and authorize access thereto to network and/or Web-based services accessible via the service access module 106. In some embodiments of the present invention, the system 10 allows browser-based, browser-challenged, and/or browserless remote devices to access these services, or a selection thereof, when such remote devices are operated at a public access hotspot supported by the system 10.

For example, the network access module 106 may be configured for receiving identifying data from a remote device 102, and communicating this identifying data to the service access module 112 for authentication and authorization. Once the identifying data is authenticated, the service access module 112 will authorize that the remote device 102 access the network 104 and services 114 provided therethrough. In some embodiments of the present invention, the system 10 may be configured to provide full access to each remote device 102, or again each remote device type, or provide restricted access to selected services 114 based on user information, remote device owner or type information, service provider information, related purchase information, service promotions offered by service provider partnerships or agreements, and/or a combination of the above and other such information available through the system 10. Identifying data may, for example, comprise remote device type data automatically embedded within remote device transmissions and extracted by the system 10, remote device type data extracted from user preferences available from the remote device, user data input thereby using a user interface (e.g. username and password, etc.), or a combination thereof, to name a few.

In some embodiments, user information or data resides or is entered or stored on the remote device and is compared to a user profile stored in a knowledge base operatively coupled to the service access module. In some embodiments, as an aid to authentication, at least a portion of user information is not stored on the remote device but is provided by the user when access is required. Similarly, in some embodiments, remote device information or data resides or is stored on the remote device and is compared to a remote device profile stored in a knowledge base operatively coupled to the service access module. Remote device information can be indicative of inherent characteristics of the remote device, such as a MAC address, or can be other information stored on the remote device for identification thereof.

Authorization or restriction of access to selected services can be enabled by establishing one or more service profiles. A service profile can associate information about users, remote devices, hotspot providers, hotspot locations, or service providers, or a combination thereof with a collection of allowed or restricted services, resources or applications to be provided. For example, the service profile can include information about services which a user has paid for and subscribed to, services usable by a remote device, and/or services offered by a hotspot provider, hotspot location, or service provider. As another example, the service profile can additionally include information about service offerings provided to specified combinations of user, remote device, hotspot provider, hotspot location, and service provider. Service profiles can be stored in a knowledge base, and accessed to determine what access should be given upon initiation of a connection of a remote device at a hotspot.

In some embodiments, the user profile and/or remote device profile are associated with the service profile in the knowledge base. During authentication and authorization, user and/or remote device information provided by the remote device is compared with the user profile and/or remote device profile in the knowledge base for validation, and access to services as described by the service profile are granted upon validation.

In one embodiment, authorization constraints can be associated with a service profile and used to directly or indirectly limit or disable specified applications, or to limit or disable network access functionality related to said specified applications. Authorization whitelists can also be used, as an alternative to or in conjunction with authorization constraints, to positively define access to services or to provide minimum service level guarantees.

The system 10 generally provides one or more remote devices 102 access to one or more services 114 via network 104. For example, the system 10 could be used to provide access to digital home services, such as access to digital TV or other forms of home content to access applications such as, but not limited to, Slingbox, Orb, Location Free TV (LFTV), and/or home security features provided by various online home security service providers. A user could thus connect to a home access system (e.g. a home media server, networked computer, etc.) to access images, music, videos, files, and the like that are stored on remote devices located in the user's home, business, office, etc. The system 10 could also be used to access remote media services, for example from another remote device 102 supported by the system 10, from a Web-enabled media service provider (e.g. music and/or video download, sharing, etc.), or from other such networked services.

Other examples of services 114 could include access to instant messaging services, such as but not limited to, AOL™ Instant Messenger, Microsoft™ MSN Messenger™, Yahoo!™ Messenger, ICQ, or Google™ Talk, access to various public, private and/or enterprise email services, such as but not limited to, Hotmail, Gmail, Yahoo!™ Mail, AOL™ Mail, Microsoft™ Outlook™, as well as access to enterprise business applications such as, but not limited to, collaborative platforms using, for example, Microsoft™ Unified Communications (e.g. Outlook™, Messenger, Sharepoint™, Microsoft™ Communications VOIP services, etc.), and the like. Access could also be provided to social networking applications such as Facebook™, MySpace™ and YouTube™. Access could also be provided to cloud storage systems such as SkyDrive™ and Google Docs™, or other virtualized computing resources. Furthermore, access to various gaming services, such as OGSi, GamePal™, PlayStation™ Network, Xbox™ Live™, Nintendo™ Wi-Fi, and the like, could also be implemented via system 10.

In some embodiments, services can be characterized at least in part as allowing access to groups of applications, and/or as allowing access to specified network resources at specified levels. For example, network resources can include sets of one or more TCP or UDP ports, data transmission or reception capabilities at a specified bandwidth, bandwidth variation, delay, delay variation, communication priority, support for specified sources or destinations, application or removal of packet size restrictions, and the like, as applied to either upstream traffic, downstream traffic, or a combination thereof. Specified network protocols, for example protocols supporting streaming video or audio, can also be considered network resources.

In some embodiments, services characterized by allowing access to groups of applications and/or specified network resources or levels thereof can be further characterized by other aspects, such as allowing access to specified applications, to specified remote devices or at specified locations, times, or the like.

In some embodiments, network resources such as described above can be selectively allowed or blocked in order to enable or disable access to one or more selected applications. For example, if a customer subscribes to a streaming audio application, access to appropriate TCP ports, streaming audio servers, and network traffic characteristics representative of streaming audio can be allowed such as support the streaming audio application. However, communication with streaming video servers may optionally be blocked unless the customer pays an additional fee. Applications and/or groups of applications can be profiled to associate therewith the network resources or characteristics required for access thereto. Service providing access to selected applications can then be enabled by allowing access to the network resources or characteristics associated therewith, for example by looking up the appropriate associations in a knowledge base.

It will be appreciated by the person skilled in the art that access to any one, or combination of the above, and other such services may be provided to a user of the system 10, without departing form the general scope and nature of the present disclosure. For example, a user could gain access to the Internet, or similar network structures, on an open access basis, such that this user could browse the Internet, download from the Internet, play online games, etc., in one example, restricted only by possible functional, processing and/or communication capabilities and limitations of the user's remote device 102. Alternatively, access could be limited to services selected or pre-selected for a given user or user remote device, identified and authenticated by the service access module 112 and authorized to access these limited services via the network access module 106.

As introduced above, in accordance with some embodiments of the present invention, the system 10 may be configured to manage public and/or private network access for a plurality of remote devices 102, optionally of a plurality of remote device types, configurations and/or functionality, and that, within a variety of venues if necessary. In this embodiment, identification, authentication and authorization can be implemented for a variety of remote devices and/or users, and optionally, for different services and service access packages and/or restrictions. Such packages could, in various embodiments, be defined by the type of remote device used to access the system 10, e.g. based on remote device capabilities, functionality and/or limitations; the specific user or remote device accessing the system 10, e.g. based on a user and/or remote device profile listing selected and/or pre-selected services; or a combination thereof, for example.

For instance, in one embodiment, access is provided in accordance with a selected or identified service access package wherein access is provided to one or more

Value Based Applications (VBAs) selected or offered to a given user and/or remote device. For example, VBAs can be offered either at no cost or as part of a paid service. Such VBAs may include a number of remotely operable applications or service levels for which an end user may wish to gain access via the present system. For example, a VBA could comprise a specific application to which access is provided via a mobile network, managed by remote device and/or network specific functionality, and priced according to the value delivered by the specific application to a specific market segment. As another example, a VBA could comprise enabling a combination of capabilities and/or service quality levels that are desired for effectively using a specific application or class of applications, priced according to the value delivered thereby. Pricing can include monetary payment, but can also be affected by other factors such as purchases of related products, services or service contracts, association with a selected service provider, or the pre-existence of other related products, services or service contracts.

Enabling VBAs may thus provide access and cost flexibility to the end user through specifically defined service profiles. These service profiles can be packaged into a monetized service based on a specific functionality, for example, gaming, home connect, etc., and tied to the remote devices that support such functionality. Furthermore, an embodiment can be configured to enable the identification of a remote device 102 as a browser-based, browser challenged, or browserless remote device, and optionally configured to combine such remote device identification with user identification. Embodiments can allow for access to the network 104 and services 114 using a service-based accounting, which permits users with browserless remote devices to access these networks 104, and can also facilitate service-oriented network access at hotspots and other such locations.

In some embodiments, a user can select and pre-pay for a service profile based on price and desired functionality. Options to upgrade a service profile can be provided, triggered by a user's attempt to access a service other than described in their service profile, or to access a service in a manner other than described in their service profile (for example but not limited to: beyond a predetermined time limitation, outside of authorized hotspots, outside of a predetermined geographic area, using an unauthorized remote device or remote device type, accessing an unauthorized application, simultaneously using more remote devices than is authorized, or using resources beyond a predetermined bandwidth cap or bit cap). It will be understood that a variety of pre-paid or pay-as-you-go service plans can be implemented in the present invention.

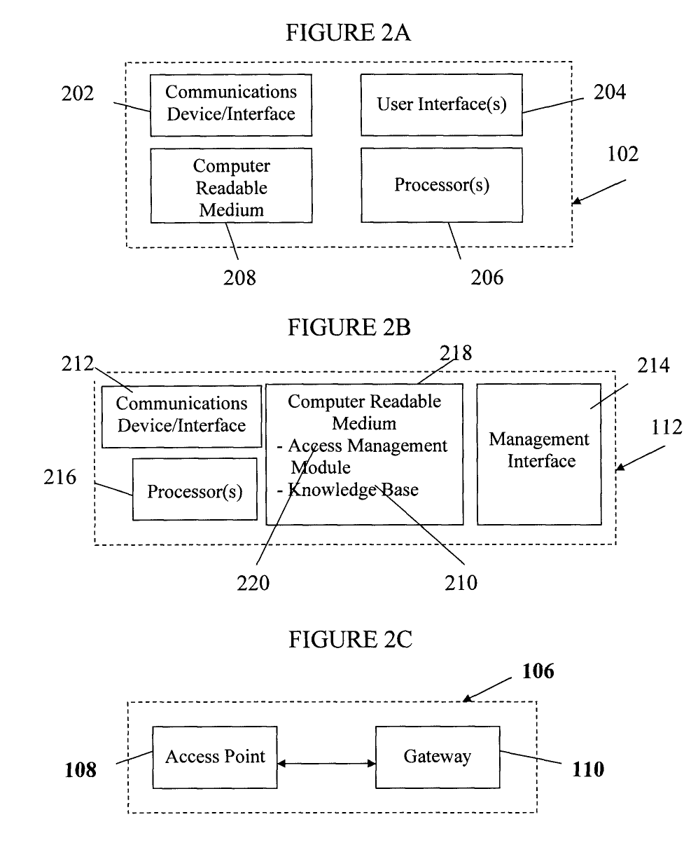

As examples of enabling restricted access to selected VBAs, a user may be willing to pay a fraction of the traditional hotspot access price for a specific function or application, for example, offering, at a discounted price, to only connect a given user to their home computer, watch TV from their home digital cable box, access a social application such as Facebook™, or keep a son or daughter entertained at the airport during a 3-hour layover with a hand-held gaming remote device connected to other players on the Internet. In an embodiment where such authorization packages are selected, the system 10 can be configured to manage user accounts and apply customized authorization rules, such as whitelists or constraints (e.g. firewall rules via gateway 110 of the network access module 106 of FIG. 2C) such that a user may select only services 114 they wish to pay for, or free services provided at their location, which for example could be in conjunction with the purchase of another product at the location or a service partnership or agreement, and be restricted thereto. An upsell feature may also be implemented through the system 10 such that a user may chose to upgrade their service profile to gain access to further services 114.

As another example, quality of service, packet priority, bandwidth, traffic shaping, and the like, can also be affected by a service profile. The service profile can be influenced by user and remote device profile information, or service provider information. For example, a user may be willing to pay a premium for improved levels of service through adjustment of the service profile, selected remote devices or remote devices associated with selected service providers can be automatically given improved levels of service through adjustment of the service profile, or a combination of such factors can influence adjustment of the service profile. In some embodiments, service levels as specified by a service profile can also be dependent on other factors, such as remote device, remote device type, location, application, and/or the like.

As another example, a service profile influencing access to predetermined functions or applications can be determined according to marketing and sales strategies. For example, access can be linked to a purchase at a hotspot providing network access services. Such an offering could be free access to one or more applications when a coffee is purchased using a stored-value card. As another example, a frequent user at a hotspot could be given a preferred pricing rate, extended time allowances or enhanced access to applications based on previous history of purchases at the hotspot or selected affiliates. Influencing service profiles, for example by a service provider or hotspot location, can be performed on a permanent or trial basis, for example for market or technical research purposes.

It will be appreciated that various service packages providing access to one or more VBAs may be contemplated in the present context without departing from the general scope and nature of the present disclosure, as can various examples, types and configurations of VBAs be combined or provided exclusively in the context of a predefined or custom service package. Furthermore, as will be described in greater detail below, various upsell mechanisms and opportunities may be provided within the present context to provide a user access to additional services, either as a supplement to an existing subscription package, a one-time trial or limited subscription, or the like, for example. Service profiles, service provider partnerships, and the like can be combined to offer access to services such as communication resources, internet, email or social applications, based on one or more factors such as location, time of day, remote device type, remote device service provider, hotspot service provider, and the like.

### Network

With reference to FIG. 1, the system 10 may be implemented over various different types and combinations of networks 104 providing for the communicative interfacing of a given remote device 102, network access module 106 and service access module 112. For example, network 104 may comprise a combination of networks conducive to provide a user access to a diversity of services 114. For example, network access may be provided to Sling Media™, which allows a user to connect to their home Slingbox™ device from a remote location; Sony™ Location Free TV, which allows a user to connect to their home Location-Free TV (LFTV) from a remote location; and/or Orb Networks™, which allows a user to connect to their home Orb™ server and retrieve content from their home server from a remote location. Access to other Internet, Web-enabled and/or network services may also be contemplated, including, but not limited to email and messaging services, media access services, gaming services, business collaboration software, social applications, and the like.

In one embodiment, the system 10 comprises a single-cell hotspot wireless network, generally comprising a local area network (LAN) or the like limited to a relatively small spatial area such as a room, a single building, a ship, or an aircraft, otherwise commonly referred to as a single location network.

In another embodiment, the system 10 comprises a wide area network, such as, but not limited to a muni-Wi-Fi network or the like, and is implemented using one or more of a variety of technologies such as a strand-mounted network, a mesh network, and the like. A wide area network could comprise, for example, a metropolitan area network (MAN) that connects two or more LANs together but typically does not extend beyond the boundaries of the immediate town, city, or metropolitan area. Multiple routers, switches, and/or hubs can be connected to create a MAN usable in the present context.

In another embodiment, the system 10 comprises a wide area network (WAN), such as, but not limited to a WiMAX Network or the like. A WAN could comprise, for example, a data communications network that covers a relatively broad geographic area using transmission facilities provided by common carriers, such as telephone companies, interne companies, and other such communication service providers.

It will be understood by the person skilled in the art that various other types and combinations of networks, either currently implemented or developed in the future to facilitate communications over diverse geographical areas, may be considered herein without departing from the general scope and nature of the present disclosure.

### Remote Device

With reference to FIG. 1, and in accordance with some embodiments of the present invention, a remote device 102, such as a wireless remote device, is a device having the ability to communicate with other devices without having physical contact with them. A remote device can be an electronic device operable as a wireless interface between a user or another electronic device and a network or wireless access point, such as provided at a hotspot or within a wireless network coverage area. A remote device may include, but is not limited to, laptops, Personal Digital Assistants (PDA), Smart phones (e.g. Apple™ iPhone™, HTC S261, RIM Blackberry™ BOLD, etc.), wireless gaming devices such as the Nintendo DS™, the Sony PSP™, the Sony Mylo™, Wi-Fi Cameras, portable entertainment devices (e.g. Apple™ iPod™, iPod™ Touch) and other such devices currently available on the market, in development, or upcoming and based on similar communication platforms and technologies. A remote device may incorporate several functionalities such as those listed above. A remote device can be capable of communicating using one or more different communication modes, such as a combination Wi-Fi and/or cellular device. The person skilled in the art will appreciate that the system 10, as disclosed herein, is readily adaptable to new and upcoming devices, and as such, is considered to include such devices within the context of the present disclosure.

With reference to FIG. 2A, and in accordance with some embodiments of the present invention, a remote device 102 is depicted. In this embodiment, the remote device 102 generally comprises a computer-readable medium or media 208 for storing statements and instructions for the operation of the remote device, and optionally for storing various forms of data useful in the implementation of remote device functions and/or accessible to the user of the remote device as needed; a communication means such as a communication device and/or interface 202 for interfacing with the network access module 106 and optionally, for direct communication with other similarly configured remote devices; one or more processors 206 for processing received and sent information and for implementing statements and instructions stored on the one or more computer-readable media 208; and a user interface (UI) 204, such as a graphical user interface (GUI), keyboard, keypad, game pad, mouse, scroll ball, touch screens, motion sensing user interface, speech recognition system, or the like for receiving input from the user directed to the operation of the remote device 102. Other remote device elements and/or components, as would be readily apparent to the person skilled in the art, may also be considered herein without departing from the general scope and nature of the present disclosure. For instance, various hardware, firmware and/or software may be integrated or operationally associated with a given remote device 102 to achieve various functions and interface with the user and/or various services accessed thereby over the network 104. Also, various peripheral devices, such as supplemental user interfaces, data input and/or output means (e.g. printers, scanners, removable storage media, etc.), and the like may also be considered herein.

In one embodiment, the remote devices 102 may include browser-based remote devices, wherein such remote devices comprise a browser-based user interface 204, such as a Web browser or the like. Examples of browser-based remote devices may include, but are not limited to laptops, PDAs, and the like.

In another embodiment, the remote devices 102 may include browser-challenged remote devices, wherein such remote devices comprise a browser-challenged user interface 204, such as for example, a microbrowser or the like, and/or comprise a substandard keypad (i.e. non-QWERTY keypad). In one example, a microbrowser is defined as a Web browser specially designed for a hand-held remote device and embedded within the software and/or firmware of this remote device. In this example, the microbrowser is generally optimized so as to display Internet content most effectively for small screens on portable remote devices and have small file sizes to accommodate the low memory capacity and low-bandwidth of such handheld remote devices. Examples of browser-challenged remote devices may include, but are not limited to, a Sony™ PSP™, a Smartphone (e.g. Apple™ iPhone™, HTC S261, etc.), a Blackberry™, and the like. Content providers may, in some instances, be configured to provide pre-formatted content specifically for some or all browser challenged remote devices.

In another embodiment, the remote devices 102 may include browserless remote devices, wherein such remote devices comprise a browserless user interface 204, for instance comprising a display and the ability to accept user inputs (e.g. keypad(s), scroll ball(s), etc.) but not encompassing the functionality common to browsers and microbrowsers. Examples of browserless remote devices may include, but are not limited to, a Nintendo DS™, a Wi-Fi camera, and the like.

The person of ordinary skill in the art will appreciate that other browser-based, browser-challenged and browserless remote devices may be considered herein without departing from the general scope and nature of the present disclosure. This person will further appreciate that, although the above examples have been described with reference to three distinct categories, other categories may also be contemplated based on each remote device's functionality, operability and user interface characteristics. Furthermore, it will be understood that certain remote devices may be best described as falling between any of the above categories, and that such remote devices are considered within the context of the disclosed system 10.

### Network Access Module(s)

With reference to FIGS. 1 and 2C, and in accordance with some embodiments of the present invention, the network access module 106 of the system 10 comprises a wireless access point (WAP) 108 and a gateway 110. In this embodiment, the WAP 108 comprises a device configured to connect different wireless communication devices together to form a wireless network, and further connect to one or more wired or wireless networks (e.g. network 104), namely via gateway 110, to relay data between remote device(s) 102 and downstream wired and/or wireless devices.

In one embodiment of the present invention, the WAP 108 reacts substantially immediately when a remote device 102 scans for an available network. The WAP 108 reacts to the remote device scan by communicating to the remote device 102 that there is an available network connection through the network access module 106.

The gateway 110 can be used to communicate between a remote network and another network, which, in the present context, may provide access to the service access module 112. In this embodiment, the gateway 110 comprises a device configured to communicate between two or more networks which may, for example, use different network protocols (e.g. wireless network protocols, wired network protocols, etc.). Examples of gateways 110 operable within the context of system 10 may include, but are not limited to, Colubris Controllers (e.g. MSC-3200), Cisco™ WLAN Controllers (e.g. Cisco™ 2000, 4100 WLAN Access Controller), and Mikrotik™ RouterOS, to name a few.

In one embodiment of the present invention in which a browser-based or browser challenged remote device is being used to access a network, the gateway 110 may intercept the request to access the network 104 and redirect the request back to the remote device 102 through a web browser for the user to input user information. The information requested can be for example, but not limited to, a username and password. The user information can be associated with a user profile for identification, authentication and authorization. Specific remote device information may also be extracted by the Service Access Module 112 (described below) from data communicated through the gateway 110 for the purposes of identifying and/or authenticating the remote device being used to access the network. Such remote device information may include, but is not limited to, the Media Access Control (MAC) address of the remote device 102, traffic type (e.g. communication port, data type, communication protocol, traffic headers, etc.), browser type (e.g. full browser, microbrowser, browser origin and/or configuration, etc.), and/or some other unique identifier (e.g. remote device configuration, serial number, signature related to a remote device clock or crystal oscillator, etc.). This and related remote device information can be associated with a remote device profile for identification, authentication and authorization. The gateway 110 receives the user and/or remote device information through the access point 108 and communicates the identifying information to the service access module 112 for authentication and authorization. Once authorized, network access is implemented, either as wide open access, or as restricted access based on a number of access authorization criteria, which may depend on the remote device type, the remote device configuration, the specific remote device, the specific user, and/or other criteria, or combinations thereof.

In one embodiment, the remote device profile and the user profile can be configured to indicate that network access is to be implemented without further interaction from the user, such as entering a user name and password. Authorization substantially without user interaction, for example based on user profile information and remote device profile information which is automatically transmitted by the remote device, is referred to herein as Express Authentication. In one embodiment, Express Authentication can further include expedited user interaction, for example, by requiring only a “one-click” or “one-action” connection confirmation from the user or requiring only a password or other convenient user data, such as biometric data, to connect.

In some embodiments, information used for authentication can include user provided information, remote device or remote device type information, and/or other information such as one or more of: user credit card information, prepaid service card information or PIN, user or remote device subscription information, access information or access history, prepaid or stored value card or smart card information for a hotspot or associated product or service provider, PIN distributed for promotional purposes, location information, usage time, date or time of day information, or other information as would be understood by a worker skilled in the art.

In some embodiments, authentication can be performed using information readily accessible. Additionally, if the information initially available for authentication is insufficient for making an authentication decision with a predetermined level of certainty, additional information can be obtained. For example, authentication can be initially based on device information transmitted during an initial connection request, with an option to request a user name and/or password if said transmitted device information cannot be used to uniquely identify the remote device. As another example, information resulting from a transaction related to the remote device can be used to support authentication. For example, if a user pays for a service or associated product or service with a prepaid or stored value card such as a smart card at the hot spot, information resulting from the transaction can be used to support authentication. This may require correlating said transaction with the remote device, for example by entering a PIN on the remote device that is printed on the transaction receipt. As another example, contextual information such as time of day or location information can be used to support authentication. For example, usage time and location patterns of a remote device can be tracked, and if a remote device requests an atypical service or requests service in an atypical location, time of day information may be used to determine whether it is more likely that the user's information or remote device has been stolen or whether the user or remote device is associated with an atypical purpose for that user (such as vacation or leisure time instead of work time).

In some embodiments, user and remote device profiles are managed, for example by a security management module and/or access management module, to reduce or deal with potential fraud, remote device theft, password theft, or other misuse, and to improve user experience and access control. For example, information or suspicious activity can be logged, tracked and reported to assist in managing fraud, theft or other misuse. Security management can include automated or semi-automated management, or management by one or more service providers on behalf of the service providers themselves, other service providers, or users. Management can include applications or services enabling tracking and analysis of remote device or user activity, management of services, service contracts, manual or automated payment options, and the like.

In some embodiments, security is managed by one or more of requiring users to provide username and/or password information; restricting access parameters such as session time limits, concurrent usage by the same user, geographic location, and/or the like; and other methods such as Express Authentication, Advanced Device Profiling, multi-factor authentication, authentication using an SMS messaging system, and fraud detection, or other methods as would be understood by a worker skilled in the art.

In some embodiments of the present invention in which a browserless remote device is used to access a network, the gateway 110 detects the remote device request for network access and forwards it to the service access module 112 (described below) where remote device information may be extracted from remote device communications, as described above. In general, the gateway 110 receives the user and remote device information through the access point 108 and communicates this information to the service access module 112 for authentication and authorization. Once authorized, network access is implemented, either as wide open access, or as restricted access based on a number of access authorization criteria. Said network access can be implemented based on the application of authentication constraints. In addition, depending on remote device and/or user registration settings, an optional request for user information and/or confirmation may be communicated to a distinct remote device of the registered user for confirmation. For example, a confirmation message could be sent to a user's cellular phone, or other such device, via a Short Message Service (SMS), wherein the user may then confirm via this distinct device that they are in fact attempting to access the system via their browserless remote device. In this scenario, this would allow a user to identify an event where access to the system is being erroneously and/or fraudulently attempted using their remote device and/or remote device identity. It is contemplated that other multi-factor or strong authentication systems can be implemented in conjunction with the present invention. For example RSA™ SecurID™, Phonefactor™ or similar services can be implemented during authentication. For example, location of a customer's cellular phone may be determined by cell tower association or GPS to determine the likelihood that the customer is indeed at the location where authentication is being requested. In addition, if authentication fails, the system can be configured to give the appearance that authentication has succeeded for the purposes of tracking or apprehending potentially fraudulent use.

In one embodiment, the gateway 110 may be configured to forward remote device communications to the service access module 112 where identifying data may be extracted from remote device transmissions only, wherein such identifying data may comprise remote device type information, specific remote device information, remote device configuration information and the like. Using remote device identification data only to connect can be described as a form of Express Authentication. Using remote device identification data only enables the system 10 to authorize different remote devices access to wide open services or a selection thereof based only on remote device data, and not on inputted user data. This feature may be particularly useful in an example wherein a browserless remote device seeks access to the network but wherein such browserless remote device does not include functionality of a conventional type-in user interface allowing for the input of a username and password, for example. This feature is also applicable to browser-enabled or browser-challenged remote devices, to provide more user-friendly and faster connection to network applications. In another embodiment, Express Authentication can also include automatically transmitted user information, either automatically requested of and provided by the user during authentication or stored on the remote device, or a combination thereof. For example, user information can include information stored on a cookie, or input by the user via interface with the remote device.

It will be appreciated by a person skilled in the art that the functions implemented by the network access module may be provided by a combination of a WAP 108 and gateway 110, or applied using other device architectures, known or developed, to provide such functionality. Furthermore, though the above examples contemplate forwarding remote device communications to the service access module 112 for identifying data extraction, it will be appreciated that the network access module may also be configured and adapted to extract such information from remote device communications and forward this information to the service access module, or to other modules of the system for manipulation, without departing from the general scope and nature of the present disclosure.

### Service Access Module

With reference to FIGS. 1 and 2B, and in accordance with some embodiments of the present invention, the system 10 comprises one or more service access module(s) 112 configured to communicate with the network access module(s) 106 to operatively identify, authenticate and authorize one or more remote devices 102 access to one or more services 114.

In the example illustrated in FIG. 2B, the service access module 112 generally comprises a computer-readable medium or media 218 for storing statements and instructions for the operation of the module 112, and for storing various forms of data useful in the implementation of module functions and management of the service access module 112; a communication means such as a communication device and/or interface 212 for interfacing with the network access module 106 through the network 104 and optionally, for direct communication with providers of the one or more services 114; one or more processors 216 for processing received and sent information and for implementing statements and instructions stored on the one or more computer-readable media 218; and an optional management interface 214, such as a graphical user interface (GUI), keyboard, keypad, mouse, scroll ball or the like for receiving input from a system manager directed to the management of the service access module 112.

It will be appreciated that other service access module elements and/or components, as would be readily apparent to the person skilled in the art, may also be considered herein without departing from the general scope and nature of the present disclosure. For instance, various hardware, firmware and/or software may be integrated or operationally associated with the service access module 112 to achieve various functions and interface with the remote device(s) 102, the network access module 106 and/or various services 114 accessed thereby over the network 104. Also, various peripheral devices, such as supplemental user interfaces, data input and/or output means (e.g. printers, scanners, removable storage media, etc.), and the like may also be considered herein. It will be further appreciated that the service access module 112 may be implemented centrally, in a distributed architecture, or in a combination thereof to achieve a desired functionality and level of complexity.

In the embodiment depicted in FIG. 2B, the computer readable medium 218 of the service access module 112 comprises an access management module 220 and a knowledge base 210, wherein the latter can be defined as a structured collection of records or data that is stored on the computer readable media 218. As will be described below, when a user attempts to register for an account, the network access module 106 (e.g. the gateway 110 of FIG. 2C) accesses information from the user and/or the user's remote device 102 and sends it over network 104, where it can be stored by the service access module 112, for example in a knowledge base 210. Information retrieved and stored may include such information as, but not limited to, user name, user password, account number, number of remote devices, remote device types, MAC Addresses, browser information, remote device configuration, service packages and/or user, remote device and service profiles, and the like. The database may also contain information regarding the hotspot access point (e.g. the specific network access module 106 implemented), for example, but not limited to, the hotspot access configuration and location information.

In some embodiments of the present invention, remote device information such as remote device types, MAC Addresses, browser information, remote device configuration, clock or crystal oscillator information, serial numbers, and the like, is used to create an Advanced Device Profile (ADP) for authentication purposes. The ADP can be used to identify, track, manage, and report on remote devices by remote device type, remote device model, or specific instance of a remote device. In some embodiments, for registered remote device, remote device type, or remote device class, a copy of the advanced remote device profile can be stored for access by the service access module, for comparison with characteristics of remote devices attempting to connect to services through the network access module for identification, authentication and authorization purposes. User or remote device access can be configured based on the ADP to allow access to be tailored toward the remote device, or to package access privileges with ownership of selected remote devices or subscription to selected service providers, for example. The ADP can also be used to enable Express Authentication, wherein user and/or remote device authentication can proceed with reduced or no input from the user.

In some embodiments, remote device information, for example as can be used to create or verify against an ADP, is captured during negotiation of a connection between the remote device and the network access module. For example, in one embodiment, a remote device may send a request to initiate a wireless connection with the network access module through an application such as a web browser. Depending on the remote device or remote device type, the request can contain different information, or be configured in different ways as would be understood by a worker skilled in the art. For example, a connection request can include specifically configured fields in HTTP headers, configurations of portions of a query string in a URL, MAC address, or other configurable aspects of the connection request as would be understood by a worker skilled in the art. This configuration information can be indicative of the remote device or remote device type, since connection requests by different remote devices or device types can be configured differently. For example, different types of connections can be requested in different ways by different remote devices such as laptops, PDAs, gaming devices, or the like. The information related to the connection request can be forwarded by the network access module to the service access module, the service access module configured to extract and analyze the information to obtain further information about the remote device or remote device type, for example by comparing the configuration of connection request information against one or more ADPs which relate predetermined profiles or configurations of information to one or more remote devices or remote device types typically having said profile. The further information obtained from this analysis can subsequently be used for authorization or authentication purposes.

Furthermore, as an alternative to or in addition to configuration information obtained during the initial request as described above, information about the remote device can be obtained by running a script or query on the remote device. For example, in response to a connection request by the remote device, the service access module can transmit a script to the remote device (via the network access module), or remotely trigger execution of a script already on the remote device. The script can be configured to extract and communicate identifying data to the service access module (again via the network access module). For example, a script could obtain and transmit configuration information about the web browser application, application version, host operating system, host hardware platform, language, screen size, and the like. This configuration information can be stored and accessed in ways known to a worker skilled in the art and can be indicative of the remote device or remote device type, since different remote devices can be configured differently. For example, different remote devices such as laptops, PDAs, gaming devices, or the like are typically configured differently with different hardware and software. In addition, some configuration information may not exist on some remote devices, resulting in an error when such configuration information is searched for. These errors can also be indicative of the remote device or remote device type, since it can be used to explicitly eliminate possible remote device configurations which would not typically have resulted in such errors. The information obtained and communicated by the query or script can be analyzed by the service access module to obtain information about the remote device or remote device type, optionally in conjunction with other information, for example by comparing the information against one or more ADPs which relate predetermined profiles or configurations of information to one or more remote devices or remote device types typically having said profile. The information obtained from this analysis can subsequently be used for authorization or authentication purposes.

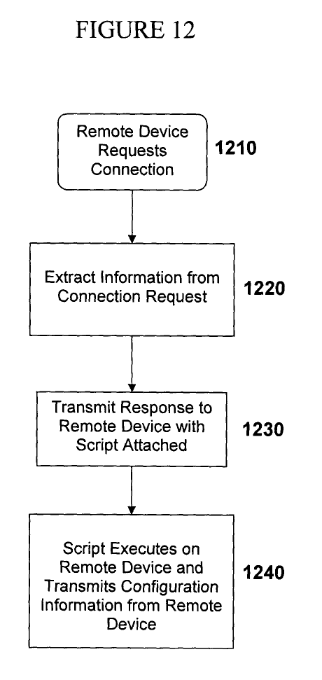

FIG. 12 illustrates an example of extracting information from a remote device according to an embodiment of the present invention. In step 1210, a network connection is requested, for example in response to a user opening a browser on the remote device. The system can respond, in step 1220, by forwarding the connection request from the network access module to the service access module, where information related to the connection request can be extracted as described above. The network access module and service access module can also respond concurrently in other ways, for example by redirecting a browser to an intercept page, and executing processes related to said intercept page to obtain user information. In step 1230, a response to the network connection request is sent from the service access module to the remote device via the network access module. A script, such as a javascript or mobile software agent, or trigger for a script existing on the remote device, is sent with the response. In step 1240, the script executes on the remote device to extract information about the remote device as described above. Information obtained by the script is transmitted back to the service access module via the network access module. Information extracted from the connection request and information transmitted by the script can then be used for authentication or authorization, for example by comparing said information to one or more ADPs to identify the remote device or remote device type, and to authenticate or authorize said remote device or remote device type accordingly.

In one embodiment, Express Authentication can be implemented, wherein user input is substantially reduced or eliminated during the identification, authentication and authorization process. In one embodiment, Express Authentication includes automatic profiling and authentication and certification of remote devices, for example by uniquely identifying a remote device based on matching selected remote device information to information stored in a knowledge base, the information being associated with a unique remote device described in the knowledge base, or by detecting mismatches between selected remote device information and information stored in a knowledge base, in order to deny authentication of a remote device. For example, if substantially all of the remote device information reported by a remote device matches a predetermined selection of remote device information stored in a remote device profile stored in the knowledge base and associated with a valid or authorized user profile stored theron, Express Authentication can be allowed. As another example, if one or more predetermined portions of the remote device information reported by a remote device do not match corresponding remote device information stored in a remote device profile stored in the knowledge base and associated with an authorized user profile, Express Authentication can be denied.

In some embodiments of the present invention, the number and type of attributes of remote device information checked against the database can vary randomly or deterministically, and in conjunction with previous history of authentication attempts, to provide efficient and convenient service while maintaining security and integrity of the authentication and authorization procedures. For example, additional authentication challenges, including multi-factor authentication challenges, can be issued or more detailed remote device information attribute analysis can be performed at random, with probability escalating with the perceived risk of fraudulent or unauthorized remote device usage. In some embodiments, Express Authentication can be satisfied by the same user or remote device in different manners, potentially resulting in different access to services.

In some embodiments of the present invention, the knowledge base 210 is a relational database. A relational database refers to a type of database wherein a table stored in the database comprises rows and columns that are populated with information retrieved from the network access module 106 (e.g. access point 108 and gateway 110). In a relational database, there are one or more tables containing stored information, which may be interrelated through one or more qualified connecting values so that information can be shared between tables.

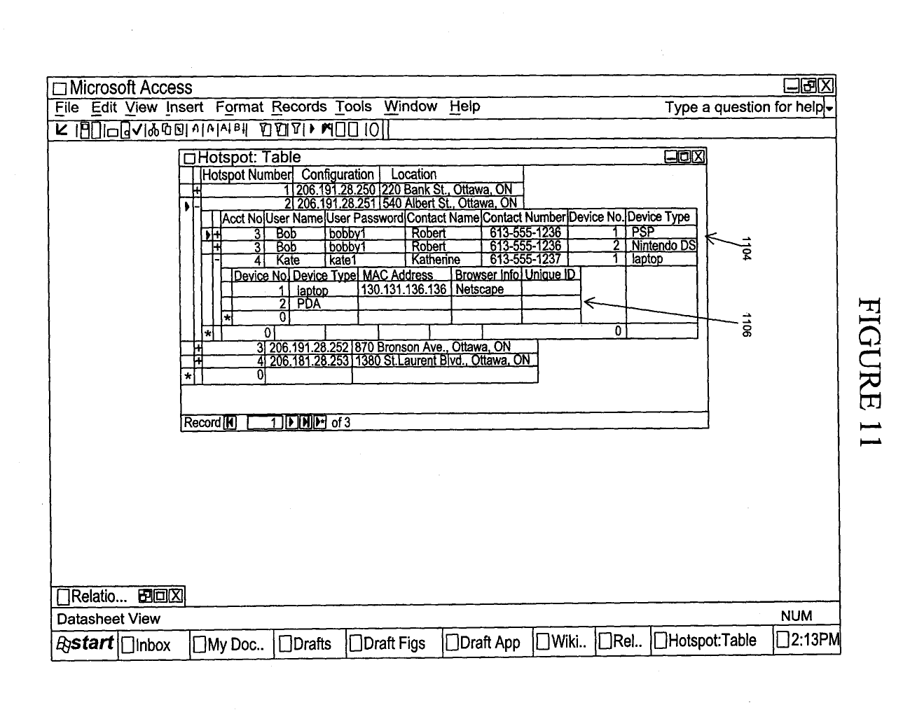

FIG. 11 provides an exemplary screen shot of such a database, namely a Microsoft Access™ database comprising sample hotspot, account, and remote device information stored in separate tables with a relationship connection to the other tables in the database. This illustration is meant to provide an example of sample information that could be stored in a database in the context of the present disclosure, wherein various types of information could be retrieved and stored. It will be apparent to the person of skill in the art that other types of database systems and structures, such as Microsoft SQL Servers or the like, could be considered herein without departing from the general scope and nature of the present disclosure.

In some embodiments, remote device information is stored in the knowledge base 210 in the form of a remote device profile, generally comprising an account variable that refers to characteristics of a remote device that allows for recognition and identification of a specific remote device, which may include, but is not limited to, known requirements of that remote device for connecting to the Internet, for example. In one or more embodiments, remote device information is collected when a user attempts to access the network via a given network access module 106, or when a user registers for a remote device account, as described below, and is stored in the knowledge base 210 for use in the authentication of the user and/or remote device when accessing the system 10. FIG. 11 provides an example of a remote device profile 1106, in accordance with an illustrative embodiment of the present invention.

In some embodiments, user information is stored in the knowledge base 210 in the form of a user profile, generally comprising an account variable that refers to information about the user retrieved from the user, including for example, but not limited to, the user's name, a created username and password, contact information, user type, preferred payment method and/or means, and the like. In one embodiment, user information is collected when a user attempts to access the network via a given network access module 106, or when a user registers for an account, as described below, and is stored in a database for use in the authentication of the user and/or remote device when accessing the system 10. FIG. 11 provides an example of a user profile 1104, in accordance with an illustrative embodiment of the present invention.

In some embodiments, a service profile is stored in the knowledge base 210, generally comprising an account variable created by a combination of one or more of a remote device profile, a user profile, an account type, and associated devices. In one example, service profiles are generally defined as subscription packages that enable subscribed users access to certain network-based functions and services, such as, but not limited to, Live TV™ from a home location or online gaming packages, as further elaborated and described above. During a registration process, defined in greater detail below, a user may be given options of services available for each type of remote device functionality. The service options can be used to limit a user's access to the Internet and/or other networks once the user chooses an option, or to expressly define, disable or enable certain access parameters, for example in accordance with aspects of relevant service profiles. Consequently, the user can then pay a predetermined price for the services selected, or have access to predetermined capabilities for free in conjunction with predetermined purchases. In one embodiment, a user can choose different packages for different registered remote devices, or may select one package that allows access to all the networks with any remote device registered.

In some embodiments, a service profile is associated with a group of authorization constraints, authorization whitelist attributes, or a combination thereof. The authorization constraints can specifically deny or block predetermined services or aspects thereof, while authorization whitelist attributes can specifically allow or enable predetermined services or aspects thereof.

In some embodiments, access to selected functions and services may be extended to all users of a given remote device type, or to all users of a given group or adhering to a same promotional package or the like, without registration and/or subscription by the user. For example, all users or remote devices falling within a given category could be entitled to access one or more selected functions and/or services attributed to this category without prior subscription or registration by these users.

In one example, a service profile is defined for a user of a laptop, a Sony PSP™, and a Windows Mobile™ PDA, who also occasionally uses a second laptop, e.g. borrowed from the user's work or elsewhere. The user of the present example could also have a Location Free TV (LFTV) at home, as well as Orb™ on a desktop system. Accordingly, the user would be able to use any of these remote devices on a supported network although there may be restrictions on concurrent usage, for example, wherein only one of each type of remote device can be connected at any time per account. By registering all the above remote devices and selecting an appropriate service package, the user can be able to access LFTV on his laptop and PSP™, or using the Orb™ device, access files from the user's home computer on his laptop, etc. while at a hotspot access location.

Furthermore, in some embodiments, an upsell feature may also be provided such that a user of a given remote device is provided the option to upgrade their current service package to include additional and/or upgraded services. For example, various upsell mechanisms and opportunities may be provided within the present context to provide a user access to additional services, either as a supplement to an existing subscription package, as a one-time trial or limited subscription, and the like. Such upsell mechanisms may be configured to market new or supplemental services at various instances during use, for example upon access to the system, periodically during use, etc., or again provide such opportunity in response to specific user actions.

For instance, in some embodiments, when a user of a given remote device having restrictive access to the system attempts to access a resource not currently permitted by the user's current service profile, for example as defined by a service profile applied to the user or the user's remote device, this traffic may be redirected to an interactive interface providing the user the option of upgrading or enhancing their service profile, for example, for an additional fee. For example, when a user or remote device registered only for gaming services attempts to surf the Web, an intercept page may be accessed instead proving the user of this remote device the option to upgrade their service profile to enable access to Web surfing functions. Other such examples should be apparent to the person skilled in the art and are thus not meant to depart from the general scope and nature of the present disclosure.

In some embodiments of the present invention, the service access module includes a Service Authentication and Authorization Manager (SAAM), which can be configured to securely provision and manage users and remote devices on networks such as Wi-Fi networks. The SAAM can be configured to authenticate and authorize users, remote devices, or combinations thereof, based on user profiles, remote device profiles, and service profiles stored in a knowledge base accessible to the SAAM. The SAAM can further be configured to authenticate and authorize users, remote devices, or combinations thereof based on service provider information, such as promotional use information, location information, time information, or other information as would be understood by a worker skilled in the art.

As an example, authentication can be based on information obtained through use of a stored value card for product or service purchases, by associating user information related to the stored value card with user profile information for authentication. For example, user information related to the stored value card can be acquired from a third party managing the stored value card. User information related to the stored value card can include cash balance information and information on history of card use, such as date and location of previous uses.

In some embodiments, the SAAM can be configured to enable Express Authentication, wherein user input is substantially reduced or eliminated during the identification, authentication and authorization process. For example, Express Authentication can enable instant or one-click secure authentication based on stored and automatically transmitted user and remote device profile data. In this embodiment, the SAAM can be configured to collect, authorize, and authenticate a user and/or remote device based on the automatically transmitted data.

In some embodiments, the SAAM is configured to collect identification data, for example automatically transmitted user and remote device profile data, without requiring a client application to be installed or configured on the remote device being identified, authenticated, and authorized. In one embodiment, instead of requiring a specialized application operating on the remote device, identification data can be collected on the basis of availability. For example, hardware information, system settings, and information embedded in applications such as Windows™ Update, iTunes™, the YouTube™ application for iPod™, or other applications residing on the remote device can all be sources of remote device information for providing to the SAAM or other authentication or authorization module. As another example, information can be extracted from standard communications with the remote device, or requested through a web browser, SMS service or other native application, or supplied using a second device carried by the user.

In some embodiments, remote device and/or user information is not automatically transmitted from the remote device, but is transmitted in response to a request or query. For example, a program, software agent, or mobile software agent such as a Java aglet can be transmitted to and/or initiated on the remote device during identification, which, during execution, gathers and transmits user and/or remote device information to the network access module, service access module, or SAAM. For example, a javascript application can be used to gather and transmit remote device information in this manner.

Service profile parameters can be dependent on other factors such as date, time of day, remote device type or remote device class, location, hotspot or business operators or venues, service profiles, simultaneous usage of remote devices by a user, session idle time or timeouts, time from expiration of prepaid or introductory service, customer loyalty, payment history, and other factors that would be understood by a worker skilled in the art. For example, frequent or preferred customers, or customers who are the focus of a marketing campaign or promotional partnership agreement, may be given temporarily enhanced service for business purposes. For example, a service profile may be created or updated to include additional services for promotional purposes for remote devices associated with particular service providers, when users of the remote device purchase a product (such as a coffee) in particular hotspot locations. The service profile may indicate for example that selected services can only be used on the day of purchase at the particular hotspot location where the purchase was made, and then only until expiry of a predetermined time period.

It will be apparent that a variety of service packages and upsell mechanisms and strategies may be considered herein without departing from the general scope and nature of the present disclosure. As any user may use anywhere from one to plural remote devices, and that, of one or more different types of remote devices, the combinations of services, remote device type service access requirements and adaptable service restrictions for each or all combination of remote devices can be implemented using the disclosed system 10 and operational embodiments thereof.

### Identification

Access to the features and services considered for in the implementation of the system 10 is generally provided via the identification, authentication and authorization of a user and/or remote device based on identifying data accessed by the service access module 112 via network access module 106.

In general, a user may access the system 10 once the user, or a remote device used thereby, is registered to access the system. In one embodiment, a user may register themselves, or one or more remote devices that they intend to use with the system 10, via a pre-registration process implemented online, in person, over the phone, or in another manner wherein information relating to the user and/or one or more remote devices are provided to a system administrator enabling registration of such identifying information for future use in an authentication and authorization process. In some embodiments, registration may be performed upon first access, or attempted access to the system 10 by a user, or by a remote device thereof. Other registration strategies, or combinations of pre-registrations, registration confirmations, direct registrations and/or updated (e.g. service upgrade or downgrade) registrations should be apparent to the person skilled in the art and as such, are not considered to depart from the general scope and nature of the present disclosure.

In some embodiments of the present invention in which a browser-based or browser challenged remote device is being used to access a network, the network access module 106, or gateway 110 thereof in the embodiment of FIG. 2C, may intercept the request to access the network 104 and redirect the request back to the remote device 102 through a web browser for the user to input user information. The information requested can be for example, but not limited to, a username and password. The gateway 110 may also forward the request and subsequent communications, if any, to the service access module 112, where specific remote device information may be extracted from such communications for the purposes of identifying the remote device being used to access the network 104. Such remote device information, for example forming part of the remote device profile, may include, but is not limited to, the Media Access Control (MAC) address of the remote device 102, traffic type (e.g. communication port, data type, communication protocol, traffic headers, etc.), browser type (e.g. full browser, microbrowser, browser origin and/or configuration, etc.), and/or some other unique identifier (e.g. remote device configuration, serial number, signature related to a remote device clock or crystal oscillator, etc.). The gateway 110 forwards the user and/or remote device identifying information (user profile, remote device profile) from the access point 108 to the service access module 112, for example, from where it can be authenticated, for example via a Remote Authentication Dial In User Service (RADIUS) protocol or other public and/or proprietary protocols, to determine whether the user and remote device 102 are registered to access the network.

In some embodiments of the present invention in which a browserless remote device is used to access a network, the gateway 110 detects the remote device request for network access, requests user information to be input via a Short Message Service (SMS), and optionally forwards the request and/or subsequent communications, if any, to the service access module 112 where specific remote device information may be extracted from such communications for the purposes of identifying the remote device being used to access the network 104. Identifying information is then used by the service access module 112 for authentication to determine whether the user and remote device 102 are registered to access the network.

In some embodiments of the present invention in which a browser-based, browser-challenged or browserless remote device is used to access the network, the gateway 110 detects the remote device request for network access and forwards the request and/or subsequent communications, if any, to the service access module 112 where specific remote device information may be extracted from such communications for the purposes of identifying the remote device being used to access the network 104. The identifying information is then used by the service access module 112 for authentication to determine whether the remote device 102 is registered to access the network.

It will be appreciated that remote device identifying data may be extracted by one or more components of the system 10, namely the network access module 106, the service access module 112, and/or any component thereof, with proper software, firmware and/or hardware configurations, without departing from the general scope and nature of the present disclosure.

In one embodiment of the present invention, registration to access the system 10 comprise two components: user registration and remote device registration. User registration can occur during the same session as the remote device registration, user registration can occur independently of remote device registration, either outside the hotspot network through a registration website, or while accessing the hotspot network.

In one embodiment, registration of a user can result in creation of a user profile stored in a knowledge base, whereas registration of a remote device can result in creation of a remote device profile stored in a knowledge base. Registration of either a user or a remote device can also result in creation of a service profile stored in a knowledge base. User, remote device and service profiles within the knowledge base are preferably linked for retrieval and association of information contained therein.

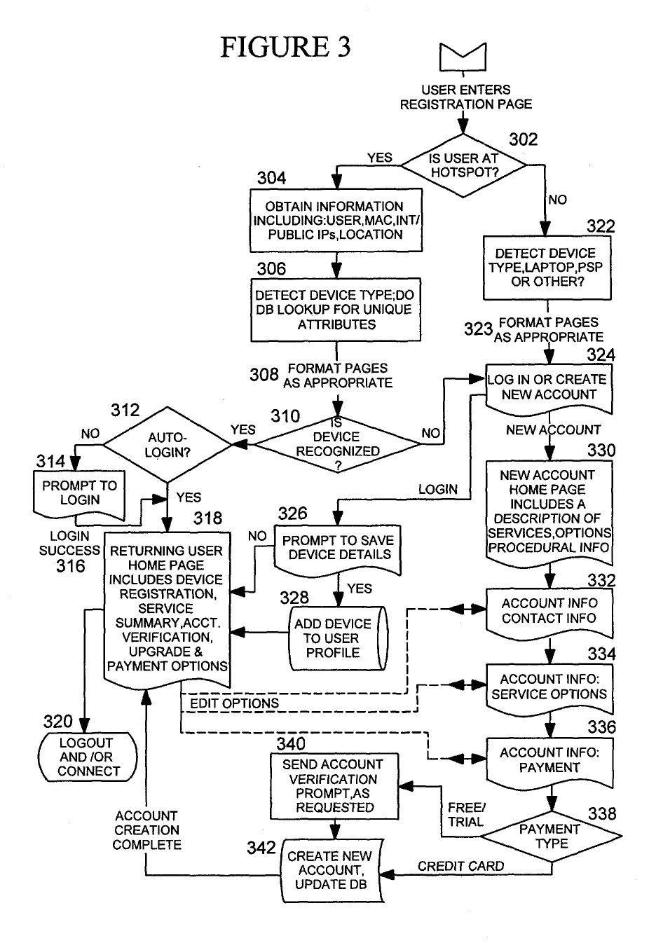

With reference to FIG. 3, and in accordance with some embodiments of the present invention, when a user registers outside the hotspot network as determined at step 302, registration occurs through a web browser interface. A user enters the website to register for an account. As the user enters the website, information about the remote device being used is stored at step 322. The website is programmed to reformat the page depending on the type of remote device used and the type of browser available at step 323. For example, but not as a limitation to the type of remote device that can be used, a laptop can use a full browser, whereas a PSP uses a microbrowser. The user selects whether to login or create a new account at step 324, depending on whether the user has previously set up an account. If the user has not previously created an account, the user selects the option to create a new account, and the browser is redirected to the new account homepage at step 330, which displays the service options, prices, and procedures available to the user. The user enters information into a form on the website and the website sends the information to be stored in a database at steps 332 to 342. The user enters contact information and selects the services to which access is desired at steps 332 and 336. The user can register more than one remote device to be used. The user has the option of paying for the services selected, which creates a new paid account in a database, or the user can select to use a free trial, and the payment or free trial option information is stored in the database at steps 338 to 342. Once the account creation is complete, the browser is redirected to the user homepage at step 318, where the user's service summary is displayed, their account verification is requested, and the user can select to register more remote devices, or choose to upgrade their services and select payment options. The user has the option to logout or connect to the network at step 320, however, since the user is not at a hotspot access point, the user generally chooses to logout.

In some embodiments of the present invention, when a user registers while accessing the hotspot network, determined at step 302, through a browser-based or browser-challenged remote device 102, the network access module 106, or access point 108 thereof, (FIG. 2C) recognizes that the remote device 102 is scanning for a network connection, the access point 108 redirects all unauthenticated remote devices to an intercept page for authentication. An intercept page is a webpage that receives user login input. While the user attempts to access the network by logging in using the intercept page, the network access module 106, or the gateway 110 thereof (FIG. 2C) stores information from the user and the remote device being used, for example, but not limited to, user name, password, MAC address, browser type, cookie information, etc. at step 304.

In some embodiments of the present invention, when a user registers while accessing the hotspot network through a browserless remote device 102, there is provided an SNMP Trap, such as but not limited to the KIWI SNMP Trap, that allows the browserless remote device user to register. The SNMP protocol is used by network management systems to monitor network-attached remote devices for conditions that warrant administrative attention. The gateway 110 detects what type of remote device is being used through key unique attributes of the remote device, for example, MAC address (including manufacturer prefix), host IP address, and other properties that can be obtained remotely through special features in the network access module 106, at step 306. For example, UTStarcom™ smartphones generally include HTTP headers such as “UA-pixels: 240×320” or “x-wap-profile:http://www.htcmms.com.tw/gen/apache-2.0.xml”.

Depending on what type of remote device is detected and/or what type of browser is being used, as explained above, the website will automatically reformat to suit the type of remote device and/or browser being used, at step 308. If the user has already registered for an account, and has registered that particular remote device as well, the system 10 will recognize the user and remote device and proceed to a login session at step 310. If the user has previously programmed his account to automatically login (for example in accordance with portions of Express Authentication), the browser automatically proceeds to the user's home page at step 312, which displays the user's remote device registration, service summary, and account verification 318. The user can choose to connect to the available services or logout of the system at step 320.

If, however, the user has not registered for an account, or has not previously registered that particular remote device, the browser proceeds to the login or register new account option at step 324. If the user has previously registered for an account but has not registered the particular remote device being used, the user chooses to login at step 324, and proceeds to allow the remote device information to be extracted and stored in a database at step 326. The user can choose to save the remote device details to their account, and access the network using that remote device, or the user can choose not to save the remote device, and is sent directly back to the user home page at steps 326 and 328. If the user has not previously created an account, the user is sent to the New Account Home Page, and is required to input contact information, select service options, and select payment options to create an account, at steps 330 to 342, providing the browserless remote device supports such functionality. Otherwise, access is not provided and registration is required via external means, such as described above.

Depending on the service and remote device in use, the user may be required to register themselves and a specific remote device 102 in order to purchase a connection and/or receive full benefit of the service. The difference is based mainly on whether the remote device to be registered is browser-based, browser challenged, or browserless.

Remote device registration is meant to be as comprehensive as possible, and some portion of the registration process may vary from remote device to remote device. The user has the option to edit their profile immediately after logging on to the system through a browser-based or browser challenged remote device, for example, the user may add another remote device to their profile. Browserless remote devices, however, are generally more limited in what applications and information they may be provided access to, based for example, on their user interfacing capabilities.

In some embodiments of the present invention, when a user enters a hotspot area with a browser-based or browser-challenged remote device 102, after the user has created a registered account in the system 10, as described above, the access point 108 sends an intercept page requiring the user to input their user name and password, or only their password, or other information that can be used to identify the user. Once the user has input their information into the browser form, the information is sent through the network 104 to be compared with valid user information stored in the service access module 112.

In some embodiments of the present invention, when a user enters a hotspot area with a browserless remote device 102, after the user has created a registered account in the system 10, as described above, the access point 108 uses a SNMP Trap to collect the user information and send it through the network 104 to be compared with valid user information stored in the service access module 112. In addition, depending on remote device and/or user registration settings, an optional request for user information and/or confirmation may be communicated to a distinct remote device of the registered user for confirmation. For example, a confirmation message could be sent to a user's cellular phone, or other such device, via a Short Message Service (SMS), wherein the user may then confirm via this distinct device that they are in fact attempting to access the system via their browserless remote device. In this scenario, this would allow a user to identify an event where access to the system is being erroneously and/or fraudulently attempted using their remote device and/or remote device identity.

In some embodiments of the present invention, when a user enters a hotspot area with a browser-based, browser-challenged, or browserless remote device 102, after the user has created a registered account in the system 10, as described above, the gateway 110 retrieves specific remote device information from the remote device and sends that information through the network 104 to be compared with valid remote device information stored in the service access module 112.

There are many different remote devices 102 that may be used with the system 10. To accurately identify a remote device there may be a number of different pieces of information needed to be retrieved from the remote device. The MAC address of the remote device is an example of one piece of information that can help identify a remote device, however, it may not be sufficiently robust, as spoofing is possible and quite simple on some platforms with the proper tools. Depending on the security levels expected from implementation of the system 10, using simple remote device identification methods such as using the MAC address may be sufficient.

In an embodiment where one seeks to reduce or avoid MAC address spoofing problems, other pieces of information may be available to help identify a remote device and can be retrieved by the gateway 110 while the remote device is attempting to access the network 104 through the access point 108. For example, some of the information that can be retrieved from a remote device that can help uniquely identify it include, but are not limited to the following: MAC address (including manufacturer prefix), browser characteristics, operating system characteristics, host IP address, traffic headers, clock or crystal oscillator characteristics, serial numbers, and other properties that can be obtained remotely through special features in the network access module 106.

### Authentication

Using identifying data provided by the user, and/or provided automatically by the user's remote device, the service access module 112 proceeds to the authentication of the user and/or remote device. In some embodiments, authentication is intended to be user-centric, for example, a user with a valid account should be able to connect to the network 104 and access those services for which he has subscribed (which may include all services available in a wide open access system), on whichever remote device 102 he happens to be carrying at that moment, or alternatively, for which remote device registration has been implemented. The characteristics of the remote device 102 and/or application attempting to connect to the network 104 can factor into the mechanics of the authentication process, and as such, the system 10 can be configured to address these factors.

In one embodiment of the present invention, authentication is intended to be device-centric, for example a remote device which is associated with a valid account should automatically or semi-automatically connect to the network through a hotspot once it becomes available. For example, Express Authentication can be used to connect a registered remote device, possibly including prompting a user to confirm said connection.

In one embodiment, a RADIUS is used as an authentication, authorization, and accounting (AAA) protocol. Such a protocol is commonly known in the art and used for applications such as network access or IP mobility. For access to a network to be granted, the information input into the remote device web browser or retrieved by the SNMP Trap, depending on what remote device is being used, is passed through the network access module 106 (e.g. the access point 108 and gateway 110 of FIG. 2C), to a RADIUS server operatively coupled to or integrated within the context of the service access module 112, over the RADIUS protocol. For example, a Network Operations Center (NOC) authentication request can cause an access-request to the RADIUS database which will return an access-accept or access-reject status. In general, the RADIUS server checks that the information is correct using authentication schemes such as Password Authentication Protocol (PAP), Challenge-Handshake Authentication Protocol (CHAP), or Extensible Authentication Protocol (EAP). If accepted, the server will then authorize access to the ISP system and select an IP address. If the username and password are correct, RADIUS will return the length of time remaining for the account and the name of the access list to use. If the account has time remaining and is not disabled, the remote device is authenticated and the access list is enforced by the access point 108. In one embodiment, the access list is what defines what a remote device can or cannot do while connected to the access point 108. The individual definitions are stored in RADIUS but loaded to the access point daily, for example, the RADIUS server will also be notified if and when the session starts and stops, so that the user can be billed accordingly.

In order to have control and flexibility over authentication and authorization, a RADIUS database may be used by the service access module 112 to provide the same programmatic potential as a proprietary local knowledge base could. The RADIUS database can contain access lists associated to the different service packages provided as described above. These advanced authentication methods allow authentication through means that extend beyond the traditional client or browser-based methods, allowing more remote devices, for example, browser challenged or browserless remote devices to connect and reconnect at public hotspots.

In some embodiments, the advanced authentication methods can allow differentiated authorization based on identification and authentication data, as well as other factors. For example, different users, remote devices, remote device types or remote device classes can be offered different services or different aspects of a service profile can be applied based on information about the remote device, location, time of day, service providers, payment, purchase of related products, service contracts, and other information as would be understood by a worker skilled in the art.

In some embodiments of the present invention, the access point 108 is configured to send an ‘Association Success’ trap to a remote Simple Network Management Protocol (SNMP) client allowing for authentication of remote devices 102 that do not invoke an intercept page, for example, browserless remote devices. SNMP is used by network management systems to monitor network-attached remote devices for conditions that warrant administrative attention. SNMP is used to collect interface information from remote devices 102. A person with ordinary skill in the art would recognize how SNMP traps are used to collect information from remote devices 102 and connected to a network 104 through an access point 108. For example, the remote device interface information can be passed through the gateway 110 to the RADIUS database, as described above, to acquire authentication.

In one embodiment of the present invention, the access point 108 is also configured to receive a request, for example, a Hypertext Transfer Protocol using Simple Object Access Protocol (HTTP SOAP) call, to retrieve the remote device IP address assigned by the access point 108. An HTTP SOAP call is an HTTP message that complies with SOAP encoding rules. A person of ordinary skill in the art would recognize that the HTTP SOAP call is only an example of a way of sending and receiving information over a network. The IP address of the remote device 102 can, for example, be associated with the remote device MAC address for enhanced authentication.

In one embodiment of the present invention, multiple SNMP clients are used, as described above, to provide scalability for concurrent remote device authentication and can be extended to support a global solution where high latency is required by the access point 108 during authentication. For example, a Kiwi SNMP client may be used to filter and/or parse messages and take actions using script. Using a scripting language, such as, but not limited to, JavaScript, a script file can be created to parse a SNMP message to extract information passed from the remote device 102 through the access point 108 via the SNMP trap, remote device information such as, but not limited to, the MAC address, the remote device IP address, or the server IP address. Once extracted, the information can be sent for authentication. In one embodiment, this process may be done asynchronously to avoid bottlenecks of SNMP messages in the SNMP client(s).

In one embodiment of the present invention, a webservice is used to communicate, for example, SNMP messages from one remote device to another through a network. A webservice is an application programming interface (API) that allows information to pass through one or more networks that may be using different communication protocols.

An example of an Authentication Webservice API could be designed to include the following elements: a AccessPointInformation function, AuthenticateDevice function which Encapsulates the HTTP request made for NOC authentication, a ConnectionInformation function, a DeauthenticateDevice function which Encapsulates the HTTP request made for NOC deauthentication, a DeviceAssociated function which provides remote device identification and validation prior to authentication, and a DeviceDisassociated function which provides remote device identification and validation prior to deauthentication.

In this example, a DeviceAssociated method is called from the SNMP client. The request is first added to a queue to wait for processing. This may be beneficial if multiple SNMP clients attempt to authenticate the same remote device association, and can reduce the number of NOC authentication attempts to the access point 108. Upon a successful authentication the duplicate authentication requests are removed from the queue.

Continuing with the above example, after queuing individual requests, the parameters are then verified and corrected if necessary. The following process checks are done:

1. Is the gateway using a Virtual Private Network (VPN)? This is determined through a lookup in a VPN database. The VPN database is populated through a custom built script that is invoked for all connects and disconnects to the VPN.

2. Is the remote device IP address available? As discussed above, if the remote device IP address is not available through the SNMP trap used, then a HTTP SOAP call can be done to the access point 108 using the MAC address to retrieve the remote device's assigned IP address.

3. Is the remote device registered? Using the MAC address, a lookup is done in the service access module 112 that stores the user and/or remote device information, to locate the account that the remote device belongs to where the account can contain the RADIUS credentials, for example, the username and password, required for NOC authentication.

With regard to this example, once all parameters are verified and complete, the NOC authentication to the access point 108 is performed. The NOC authentication can be performed using, for example, an HTTPS call to the access point 108 with the required parameters, and the result is returned as a pass, fail, or error value. Access to selected services can be based on the result. For example, if the result is returned as a pass, access can be granted, whereas if the result is a fail or error value, access is not granted, and optionally the authentication procedure can be retried.

In one embodiment of the present invention, the Advanced Device Profile (ADP) is stored in a knowledge base and used for authentication purposes.

In one embodiment, Express Authentication can be implemented using information stored in a knowledge base.

With an authentication system including multiple components, encompassing many different technologies, and spreading across multiple geographical locations, it may be effective to have a single and simple means to trace processing sequentially across all components for debugging and analytical purposes. A tracing webservice allows trace information to be sent unobtrusively as authentication moves through the process. A webservice, because of its interoperable characteristics and wide programmatic support among technologies, is one possible way to track the system process.

### Authorization

According to embodiments of the present invention, authorization occurs once the remote device 102 and/or user have been authenticated, as described above. The system 10, via the network access module 106, or gateway 110 thereof (FIG. 2C), restricts the user and remote device to actions determined by the remote device's capabilities and/or the service package purchased by the user, as described in more detail below, by setting up firewalls, allowing or blocking specified TCP or UDP ports, filtering or restricting network traffic based on type, packet headers, content, flow characteristics such as rate, delay and variation thereof, source, destination and/or other access limitation rules to be implemented by the system 10. If the user selects the wide-open Internet access option, the user will have full access to the Internet, for example. Authorization can also operate by expressly allowing a user and/or remote device to carry out predetermined actions or connect to predetermined services, instead of specifying what actions are not allowed. The sets of allowed or restricted actions are described by a service profile, including for example authorization constraints or authorization whitelists.

In one embodiment, service profiles are dependent on factors such as the amount of time a user is accessing an application, the type or content of the application, rate and volume of data downloaded or uploaded, or other factors related to application usage. These factors can be in addition to other factors, such as allowing access to specified applications, to specified remote devices or remote device types, or at specified locations, times, or the like.

In another embodiment, service profiles can be configured to enable or disable selected applications or groups of applications, either directly according to application name or type, or indirectly by setting minimum or maximum service levels for selected services such as bandwidth, delay, enabled or disabled TCP or UDP port numbers, firewall settings, and the like, where said service levels are required for certain degrees of performance of selected applications, to which a value may be associated. These factors can be in addition to other factors, such as allowing access to specified applications, to specified remote devices or device types, or at specified locations, times, or the like.

In one embodiment, in order to influence or control access to prespecified applications or services, different applications or services can be profiled. To profile an application or group of applications, the type and level of communication resources associated with usage of said application or group of applications is determined, such as TCP or UDP port usage, bandwidth, packet size, traffic characteristics, and the like. This association can be performed through controlled experimentation or monitoring of customer activity. The association between applications and type and level of communication resources is then stored in an application profile in a knowledge base. The application profile can subsequently be used to substantially monitor and/or restrict users to predetermined applications or groups of applications by monitoring and/or restricting access or usage to the associated types and levels of communication resources. Profiling of applications can be performed automatically according to an adaptive or automated procedure, or by a network administrator, or by a combination thereof.

In an optional embodiment of the present invention, the system 10 uses a value based application (VBA) which provides limited access to an exclusive application, service, or remote device connection, or a combination thereof, that is packaged, marketed, and sold at a hotspot at a price representative of its perceived value, which is discounted from wide-open Internet access that is currently provided.

Using VBA service profiling, the system 10 can be configured to identify incoming traffic substantially without user input, recognize returning users and remote devices by type, connect users with a single click, or no clicks, such as by Express Authentication, and apply rules post-authentication to allow only that type of remote device, or a service on that remote device, to connect. By possessing this functionality it is possible to assemble creative packages of service offerings which allow users to pay for only the services they will use. Alternatively, users can obtain some services for free, or obtain services at no charge or at a reduced price when another good or service is purchased. In this way, targeted marketing can also be performed in conjunction with user services in embodiments of the present invention.

In one embodiment, service profiles can be applied to determine what services to connect a user to, and the conditions required for each service. Service profiles can restrict, allow, or otherwise configure access to applications based on various factors. For example, service profile parameters can pertain to date and time ranges, remote devices, remote device types or remote device classes, for example as indicated in remote device profiles, geographic locations, hotspot or business entity identification, types of VBA services available, number of users accessing services, available bandwidth, concurrent use of multiple remote devices by a user or group of users, session idle time or timeouts, or other parameters affecting access to services, applications or VBAs as would be understood by a worker skilled in the art.

In one embodiment, service offerings can be related to providing access to one or more applications under predetermined time, quality, or other restrictions. Service offerings need not be identified with a particular application, but can be defined by potential combinations of service profile parameters such as authorization constraints or authorization whitelists. For example, a communications service provider A and an interne access service provider and product vendor B could devise a product whereby users of remote devices affiliated with A, who also purchase a product or service from B using a stored-value card, could get 1-hour free open Internet access through B at selected vendor locations on the day they make the purchase. Another communications service provider C could offer users of remote devices affiliated with C free access (or access for a nominal charge, or free access with another purchase) at selected hotspots to their Facebook account, provided the users have purchased a qualifying service plan.

Once logged into a profile, for example through an access management module, the user can have the option to, among other functions, add remote devices. Upon selecting a remote device, the user enters information required to register that particular remote device into their account. Once registered, the user selects the service package that suits his needs, and selects a payment option, and then the user can use the remote device at any hotspot access supported by system 10.

In one example, the VBA constructions define specific gateway firewall requirements for each product. By identifying settings of the servers, transports, or ports used by the remote devices and services supported by the system 10, which may include for example, but are not limited to computing devices, games, streaming video products, collaborative business applications, social applications, etc. In one embodiment, there are created Access Control Lists (ACLs) that provide proper access support for each VBA, while restricting access to other common services for which the user has not paid. These restrictions may occur at the gateway 110 level, for example, using firewalls to limit access to certain Internet and other network capabilities.

In another embodiment of the present invention, the restriction of network access may occur through funneling all user traffic through a central proxy server. This method of limiting network access according to a VBA would allow for more control, for example, of the authorization process.

In one embodiment, in order to create limited-access VBA profiles, as described above, Internet access requirements for each of the applications to be supported including servers, ports, protocols, etc. which could be used by a remote device during the execution of a certain application are identified. For example, a game on the Nintendo DS™ may require access to a Nintendo™ server, over TCP, using port 1025 outbound and 1030 inbound. An inventory for each application's connectivity requirements is used in order for the applications to be combined into product packages, the VBAs, and their requirements combined. The amalgam of the requirements for each package form the basis for firewall rules for a specific VBA. These application profiles contain information about various characteristics of each application or remote device which describe not only how the application behaves on the Internet, but unique characteristics of the remote devices which would allow instant and automatic detection of the remote device type and link a specific remote device to a unique user. These application profiles can comprise a dynamic database. For example, with new applications and remote devices being introduced, constant updating may be implemented to support new remote devices, and to ensure that users do not have problems with a new software program or application on older remote devices.

To restrict and/or prohibit access to all other available services the user did not select, for example, a user who pays for online gaming should not be able to browse the Internet or send email, requires a proper set of firewall rules for any VBA, by permitting everything required for that VBA to function, and blocking access to everything else. These firewall rules can be established based on transport protocols (e.g. TCP, UDP, ICMP, etc.), destination server (e.g. IP or DNS name), port number, traffic protocol (e.g. SMTP, FTP, HTTP, etc.), header information, etc. By combining a set of permitted servers, ports, protocols, and the like and restricting others, the firewall configuration for any one VBA can be determined.

In one embodiment of the present invention, to facilitate the post-authentication user restrictions at a hotspot, manipulation of the functionality of the gateway 110 provided is desirable. For example, some manipulation of the “access-list” attribute, which is a vendor-specific attribute used by the Colubris™ Multi-Service controllers (MSC-3200), could be used. Allowed and disallowed IP address and port combinations can make up an access-list definition which is associated to an account/remote device combination and enforced by the access point 108.

An example of such manipulation of an “access-list” attribute is described in the following steps:
(1) determining in advance a selection of packaged VBAs, and the firewall rules needed to operate them;
(2) establishing those rules in the start-up profile of the network access module 106 (e.g. gateway 110) in the form of an “access-list” such that each time the unit connects to the Internet, or at a given refresh rate (e.g. once per day), it would download instructions for “DS Gaming”, “PSP”, etc.; these instructions could be read into memory by the gateway 110, but not applied, for example, until called by a user connection;
(3) upon login, programmatically determining the subscribed VBA for that user; and
(4) calling the appropriate access-list profile for that user and activating it at the gateway 110 for that session.

The remote device profiles for each service package can be stored in a database (e.g. knowledge base 210 of FIG. 2B), and combined with one or more user profiles, a list of associated remote devices, a list of service subscriptions, or a combination thereof, to form a service profile for that user or remote device, as described above. When a user logs in, or a remote device 102 is recognized at the time of connection, the system 10 is able to look up the service profile for that user and/or remote device, determine the appropriate level of access, and apply the profile to the current connection by configuring the appropriate firewall rules at the gateway 110 following authentication.

As will be appreciated by the person of skill in the art, the system 10 may further comprise a reporting module used by network access providers, and other partners, for reporting data related to system usage analysis and billing purposes. Reports may include information regarding, for example, usage by user, location and vendor; usage by remote device type; payment type; and other such information, as would be apparent to the person skilled in the art.

It will be further appreciated that various upsell mechanisms, as described above, may be implemented so to actively upgrade a user's, or a remote device's service access package while interfacing with the system.

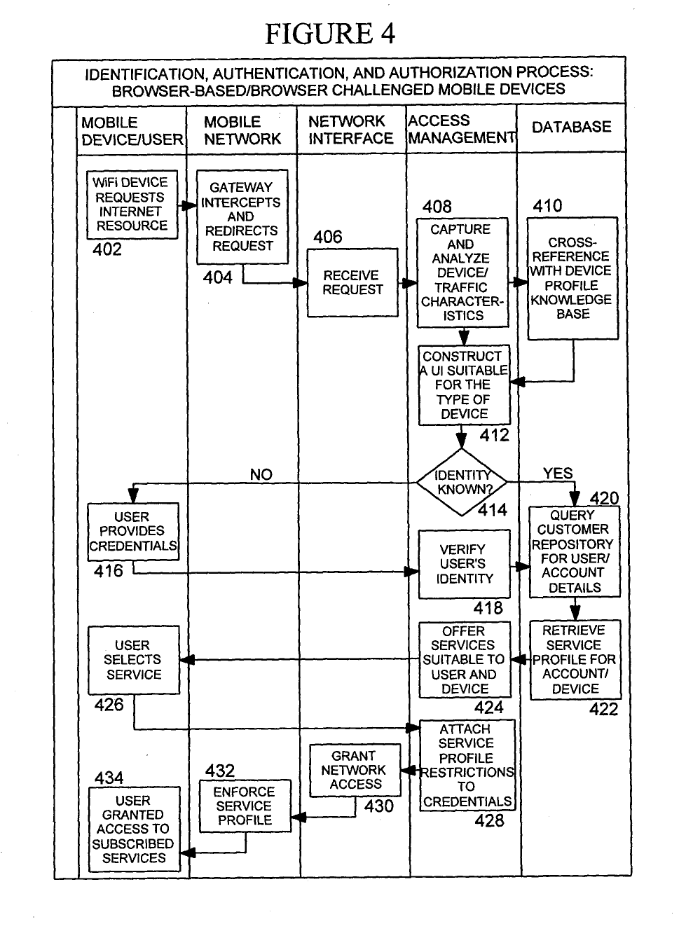

With reference to FIG. 4, and in accordance with one embodiment of the present invention, there is shown a flowchart providing a process for identifying, authenticating, and authorizing a user utilizing a browser-based or a browser challenged remote device 102 to access a network 104. In this example, the remote device 102 scans the area for an available network connection. The user invokes a web browser via which a given Internet resource may be requested at step 402. The gateway 110 intercepts the request and redirects it to the network interface at step 404. The gateway 110 also sends through the network the remote device characteristics that it has extracted from the remote device 102 at step 404. The network interface receives the request to access the network and the remote device information and sends the request on to an Access Management Module (e.g. of service access module 112 of FIG. 2B) at step 406. The Access Management Module captures the remote device and user information and analyzes the remote device characteristics to determine what information the gateway extracted at step 408. The remote device information is cross-referenced with the database containing user, remote device, and service profiles at step 410. The Access Management Module determines what type of remote device is being used to access the network and reformats the User Interface (UI) to suit the remote device's capabilities at step 412. At step 414, the process determines whether the user is known. If the user information was sent with the request, the Access Management Module sends that information to the database to retrieve the user's account details at step 420. If the user information was not sent with the request, the intercept page is sent to the remote device so the user can input their user information at step 416. The user's information is sent back to the Access Management Module at step 418 and the information is cross-referenced with the account details in the database to verify the user has an account at step 420. The database determines what service profile the user has access to through the current remote device the user is using at step 422. The process sends the available service options to the remote device through an appropriate UI at step 424, and the user selects which services to allow at step 426. The process selects the appropriate service credentials and restrictions at step 428, and sends that information through the network interface at step 430, to the gateway to enforce those restrictions at step 432. The user is granted access to the network limited to the service profile the user subscribed to at step 434.

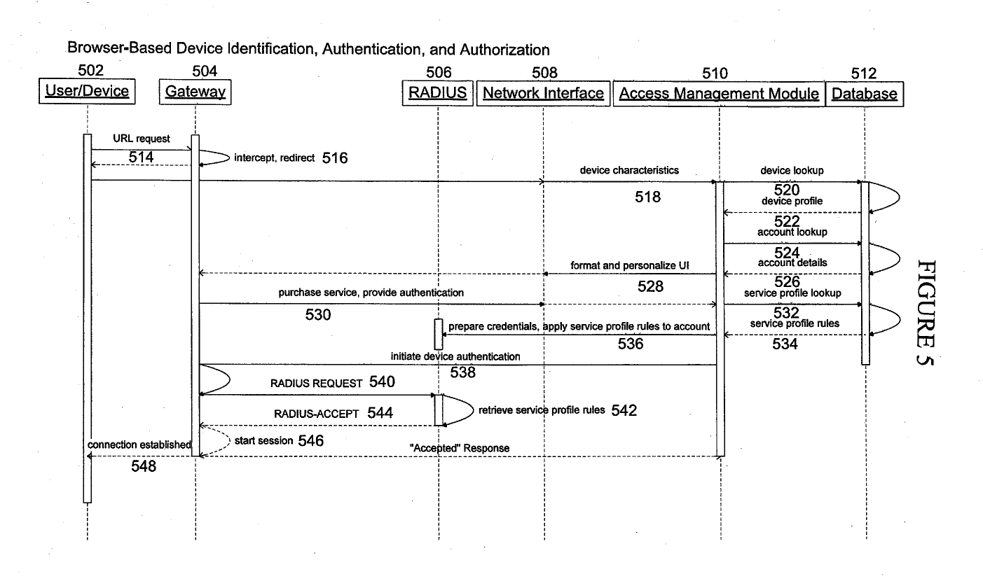

With reference to FIG. 5, and in accordance with one embodiment of the present invention, there is provided a sequence diagram providing a process for identifying, authenticating, and authorizing a user to access a network interface 508 using a browser-based or browser challenged remote device 502. The user, via the remote device 502, sends a URL request to access the network (step 514), the gateway intercepts the request and redirects the request back to the user via an intercept page (step 516). The user inputs user information through the form provided on the intercept page, and this information is sent to the Service Access Module, whereby remote device characteristics may be further extracted from remote device communications, for use by the Access Management Module 510 (step 518). The Access Management Module 510 first looks up the remote device characteristics in the database 512 (step 520) for a matching remote device profile stored in the database 512. The database 512 sends the remote device profile back to the Access Management Module 510 (step 522). The Access Management Module 510 then looks for an account profile that matches the remote device profile to compare user information (step 526). Once an account profile is found, the process formats the User Interface (UI) to suit the remote device being used (step 528) and sends a web page displaying available service options for that user and remote device to the user so the user can select the required services. The user selects the required services and selects payment options, and that information is sent back to the Access Management Module 510 (step 530) to be cross-referenced with the service profiles stored in the database 512 (step 532). A service profile is selected and the service profile rules are sent to the Access Management Module (step 534). The user's credentials in the RADIUS database are updated, and the rules of the service profile are associated with the credentials (step 536). The remote device information is sent back to the gateway 504 to initiate authentication of the remote device 502 for the services selected (step 538). The gateway 504 makes a RADIUS request to authenticate the remote device for the services selected (step 540). The RADIUS server checks the credentials and retrieves the associated service profile restrictions (step 542). The RADIUS sends an “accept” message back to the gateway 504 (step 544), accompanied by the service profile restrictions to be enforced by the gateway 504. A network session is created (step 546) and the user can establish a connection to the network 508 (step 548).

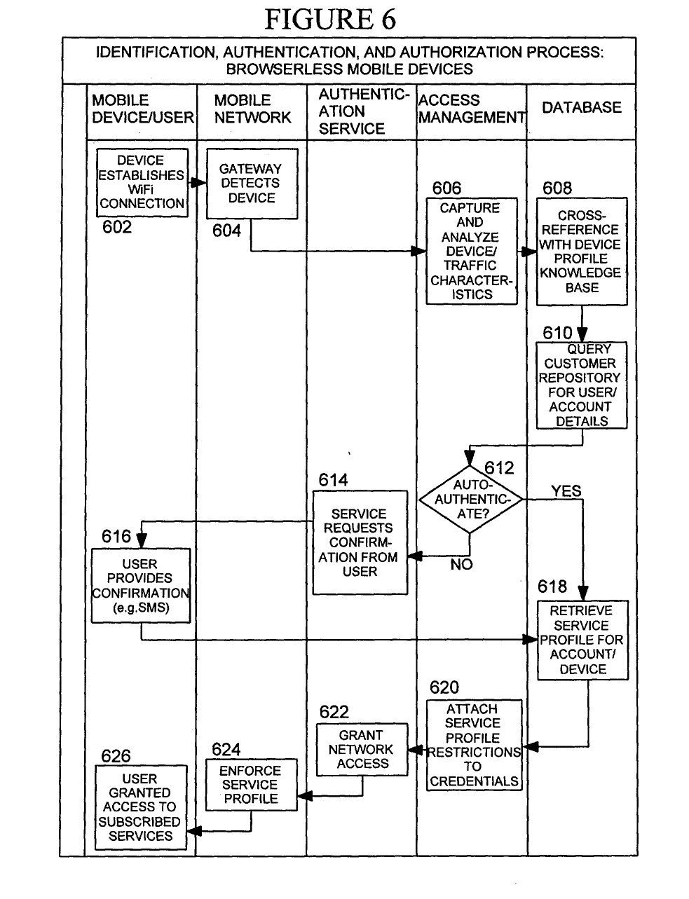

With reference to FIG. 6, and in accordance with one embodiment of the present invention there is shown a flowchart providing a process for identifying, authenticating, and authorizing a user utilizing a browserless remote device 102 to access a network 104. The remote device 102 scans for an available network connection at step 602. The gateway 110 detects the remote device scanning for a network at step 604, and forwards the remote device information to the Access Management Module to be extracted thereby. The Access Management Module captures and analyzes the remote device characteristics to determine which remote device is being used to access the network at step 606. The remote device characteristics are cross-referenced with remote device profiles stored in a database at step 608. The database is also searched for the user account profile, if one exists, at step 610, and it is determined whether the user has previously programmed the account profile to auto-authenticate when the user accesses the network at step 612. If the user has not selected to auto-authenticate, the authentication service requests confirmation from the user at step 614. The user provides user information to confirm user account information using Short Message Services (SMS) which are text messages that can be sent using devices, such as but not limited to, cell phones and pocket PCs, at step 616. The user information received from the user and remote device 102 is cross-referenced with service profiles established for the account and remote device profiles which are stored in a database 112 to determine the appropriate services to make available at step 618. The Access Management Module determines the credentials and restrictions of the selected service profile and sends those to the authentication service at step 620. The authentication service verifies the user account, remote device, and service profiles and grants network access to the user at step 622. The gateway provides the enforcement of the service profile to allow the user to only access services provided for the remote device they are using at step 624. The user is provided restricted access to the network in accordance with the services the user has provided payment for at step 626.

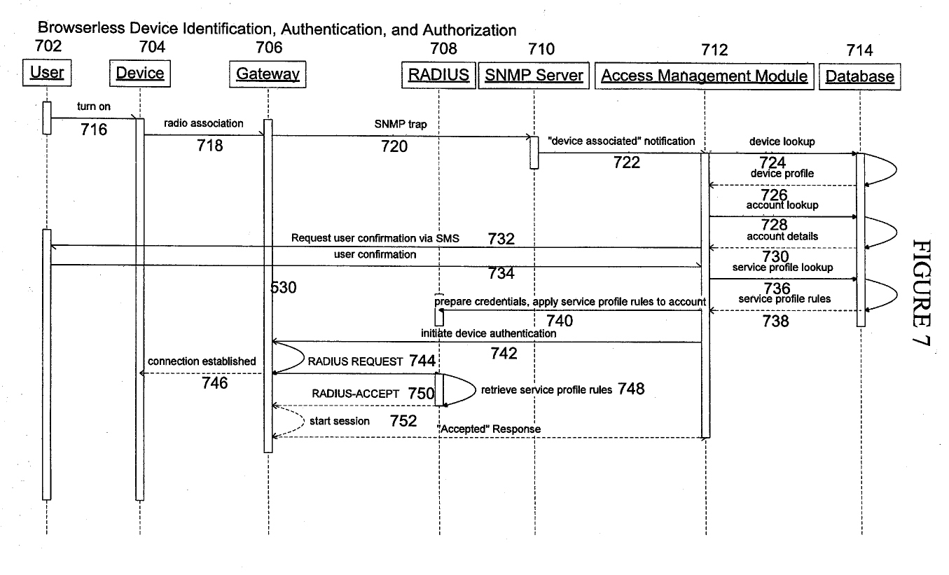

With reference to FIG. 7, and in accordance with one embodiment of the present invention, there is shown a sequence diagram providing a process for identifying, authenticating, and authorizing a user utilizing a browserless remote device 102 to access a network 104. A user 702 at a hotspot access location turns on a browserless remote device 704, for example, but not limiting to, a mobile phone (step 716). The remote device attempts to make a radio access network (RAN) connection to the available network (step 718). The gateway 706 creates a SNMP trap to extract remote device information from the remote device (step 720). The SNMP “device associated” notification is sent from the SNMP Server 710 to the Access Management Module 712 (step 722). The Access Management Module 712 cross-references the remote device characteristics with the remote device profiles stored in the database 714 (step 724). Once a remote device profile is established, the Access Management Module 712 looks in the database to see if there is an account profile associated with the remote device profile (step 728). The account profile details are sent from the database 714 to the user 702 requesting the user to confirm the account details (step 732). The user provides user information to confirm the account details through SMS, for example, and the information is sent back to the Access Management Module 712 (step 734). The Access Management Module 712 looks in the database 714 to acquire the appropriate service profile for the user and remote device (step 736). The appropriate service profile is selected from the database 714, and the service rules are sent to the Access Management Module (step 738). The user's credentials in the RADIUS database are updated, and the rules of the service profile are associated with the credentials (step 740). The remote device information is sent back to the gateway 706 to initiate authentication of the remote device 704 for the services selected (step 742). The gateway 706 makes a RADIUS request to authenticate the remote device for the services selected (step 744) while a connection is established with the remote device (step 746). The RADIUS server checks the credentials and retrieves the associated service profile restrictions (step 748). The RADIUS sends an “accept” message back to the gateway 706 (step 750), accompanied by the service profile restrictions to be enforced by the gateway 706. The gateway 706 then initiates a session (step 752) feeding back to the access management module (step 752).

### Example 1

### Process Flow of Browser-Based Devices

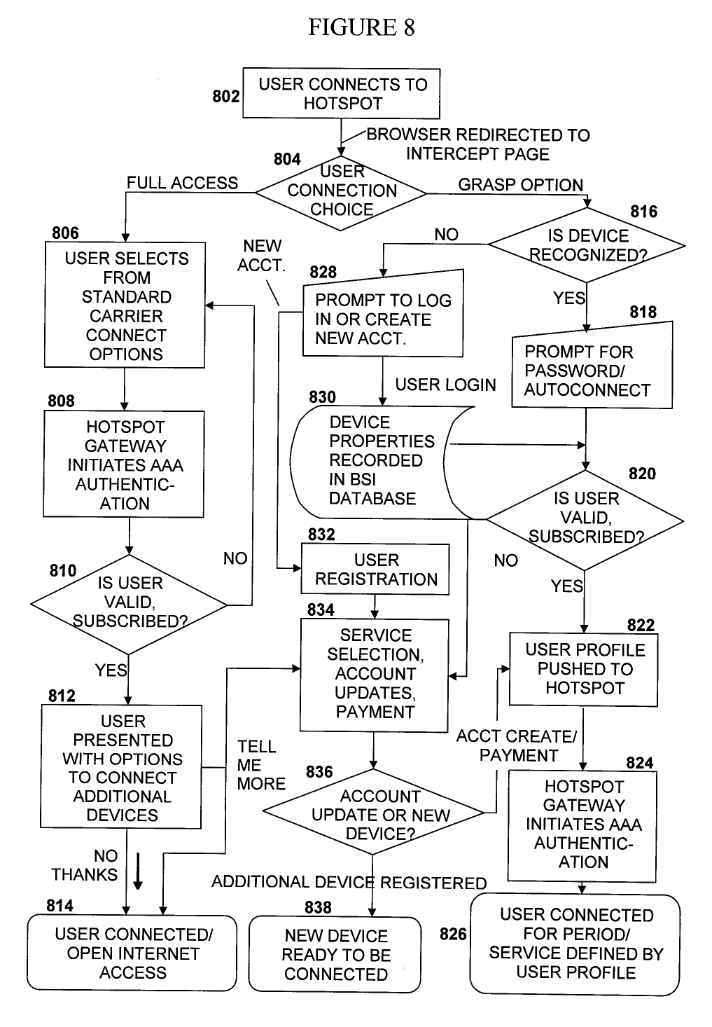

With reference to FIG. 8, and in accordance with one embodiment of the present invention, there is provided a flowchart of steps taken when a user attempts to access a network at a hotspot location, using a browser-based remote device. The user enters the hotspot location, and turns on the remote device, the remote device scans for available networks, and the user opens a web browser at step 802. The user selects whether to have full access to the network or to have a service package option, at step 804. If the user chooses to have full access to the network, the user selects the connect options provided by a carrier at step 806. The gateway initiates authentication of the user through the use of RADIUS at step 808. The gateway confirms whether the user is a valid user at step 810, if the user is authenticated, the user is given options to connect additional remote devices to the network at step 812, which would then forward them to the service package options provided at step 834. If the user chooses not to connect additional remote devices to the network, the user is connected to the Internet with wide open access at step 814.

If, at step 804, the user chooses to have access to the network based on a service package, the system attempts to recognize the remote device being used to access the network at step 816, if the remote device is recognized, the user is prompted through the web browser to input user information or the user can select to auto-authenticate, at step 818. If the user is a valid subscriber, as determined at step 820, the user profile is passed to the hotspot network access at step 822. The gateway initiates the authentication of the user, remote device, and service profiles at step 824, and allows the user to have access to the network for the services selected in the service package at step 826. If the remote device being used is not recognized at step 816, the user is prompted to login or create a new account using the web browser at step 828. If the user has previously registered an account, the user logs on, and the remote device characteristics are then stored in a remote device profile associated with that user at step 830.

If the user is a new user, they are required to create a new account at step 832. The user selects the type of service package, and payment option from the list displayed at step 834, and the account is created, and updated at step 836, and the remote device being used can then be connected to the network at step 838. The account information is sent to the hotspot network access at step 822, and the gateway initiates the authentication of the user, remote device, and service profiles at step 824, and allows the user to have access to the network for the services selected in the service package at step 826.

### Example 2

### Process Flow of Browser Challenged Devices

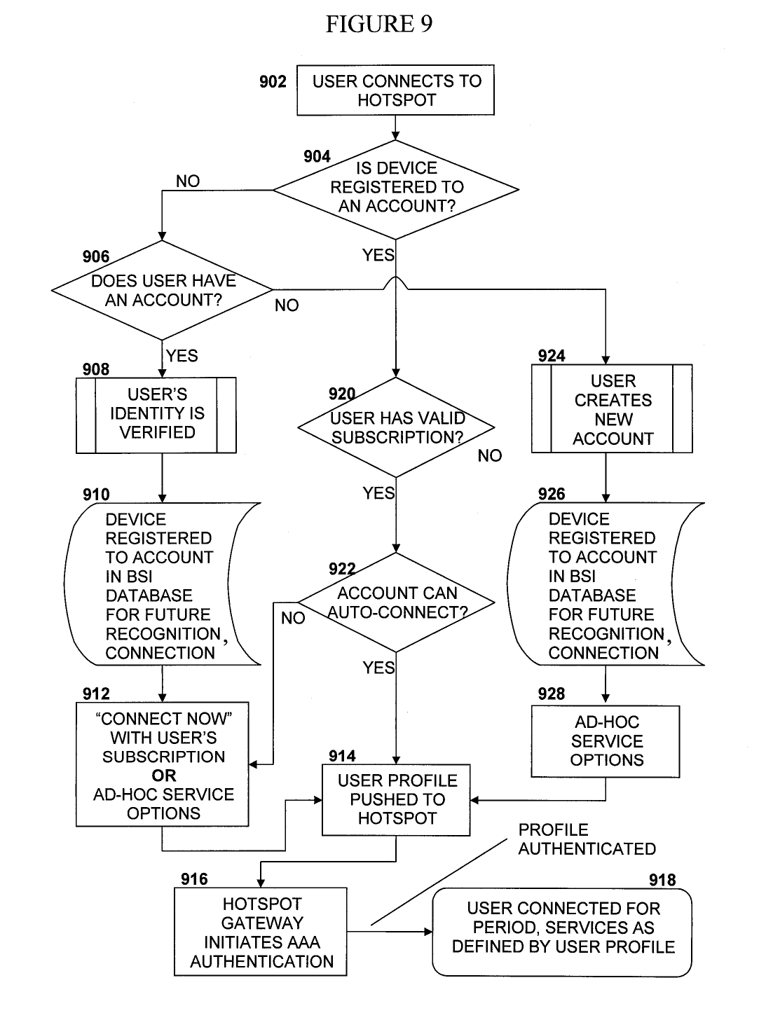

With reference to FIG. 9, and in accordance with one embodiment of the present invention there is provided a flowchart of steps taken when a user attempts to access a network at a hotspot location, using a browser challenged remote device. The user enters the hotspot location, and turns on the remote device, the remote device scans for available networks, and the user invokes a web browser at step 902. The service access module extracts information from the remote device to determine whether it is a registered remote device, at step 904. If the remote device is not a registered remote device, the gateway receives information from the user to determine if the user has a valid account at step 906. The user's information is sent to be authenticated at step 908. If the user is verified as a valid user, the remote device information is then stored as an associated remote device at step 910. If the user's service package already provides sufficient access to the network for that particular remote device, the user can connect to the network, or the user has to select service options from a list displayed on the web browser at step 912. The account information is sent to the hotspot network access at step 914, and the gateway initiates the authentication of the user, remote device, and service profiles at step 916, and allows the user to have access to the network for the services selected in the service package at step 918.

If the remote device is already registered to an account as determined at step 904, the user inputs user information at step 920 If the user information is valid, the user can select to auto-connect at step 922, or require the system to ask the user whether they wish to connect at step 912. The account information is sent to the hotspot network access at step 914, and the gateway initiates the authentication of the user, remote device, and service profiles at step 916, and allows the user to have access to the network for the services selected in the service package at step 918.

If it is determined at step 906 that the user does not have a valid user account, the user creates a new account at step 924. The remote device is registered to the user's remote device profile at step 926, and the list of service options is displayed at step 928.

The account information is sent to the hotspot network access at step 914, and the gateway initiates the authentication of the user, remote device, and service profiles at step 916, and allows the user to have access to the network for the services selected in the service package at step 918.

### Example 3

### Process Flow of Browserless Devices

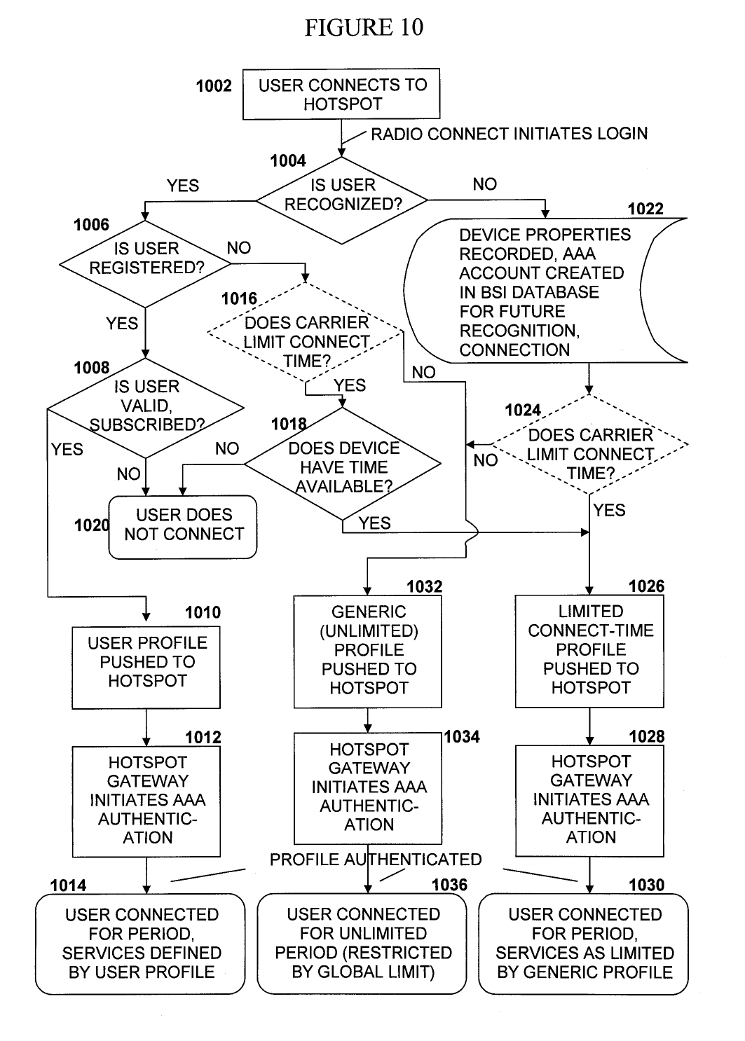

With reference to FIG. 10, and in accordance with one embodiment of the present invention, there is provided a flowchart of steps taken when a user attempts to access a network at a hotspot location, using a browserless remote device. The user enters the hotspot location, and turns on the remote device, the remote device scans for available networks, and the user begins a text message session and uses a radio access network to connect to the network, at step 1002. The gateway determines whether the user is a recognized user at step 1004. If the user is recognized, it is determined whether the user has a registered account at step 1006. If the user has a registered account, it is determined whether the user has a valid service subscription for the remote device being used at step 1008. If the user has a valid subscription for the remote device being used, the account information is sent to the hotspot network access at step 1010, and the gateway initiates the authentication of the user, remote device, and service profiles at step 1012, and allows the user to have access to the network for the services selected in the service package at step 1014.

If it is determined at step 1006 that the user is not a registered user, the system checks if the connection available to the remote device is time limited at step 1016, if it is time limited, the system checks if the remote device being used has time available at step 1018. If the remote device has no time available, the user will not be allowed to connect to the network (step 1020). If the connection available is time limited, and the remote device has time available, the limited remote device profile is sent to the hotspot network access at step 1026, and the gateway initiates the authentication of the remote device at step 1028, and allows the user to have access to the network for the limited device-specific services at step 1030. If the connection available is not time limited at step 1016, the open access to the device-specific network connection is sent to the hotspot network access at step 1032, and the gateway initiates the authentication of the remote device at step 1034, and allows the user to have open access to the network for the device-specific services for an unlimited amount of time, at step 1036.

If it is determined at step 1004 that the user is not a recognized user, the remote device characteristics are extracted and stored as a remote device profile in a database at step 1022. The remote device attempts to connect to the available network for device-specific access, at step 1024 if the connection available has a time limit the limited remote device profile is sent to the hotspot network access at step 1026, and the gateway initiates the authentication of the remote device at step 1028, and allows the user to have access to the network for the limited device-specific services at step 1030. If the connection available is not time limited at step 1024, the open access to the device-specific network connection is sent to the hotspot network access at step 1032, and the gateway initiates the authentication of the remote device at step 1034, and allows the user to have open access to the network for the device-specific services for an unlimited amount of time, at step 1036.

It is clear that the described embodiments of the invention are exemplary and can be varied in many ways. Such variations are not to be regarded as a departure from the spirit and scope of the invention, and all such variations, as would be obvious in the art, are intended to be included within the scope of the following claims.

What is claimed is:

1. A system for providing a remote device wireless access to one or more services over a communication network, the system comprising:
a network access module adapted for communicating wirelessly with the remote device and for receiving therefrom a wireless transmission comprising identifying data, said identifying data comprising remote device identification data automatically embedded within said wireless transmission by the remote device; and
a service access module communicatively linked to said network access module for receiving said identifying data therefrom, for authenticating the remote device based on said identifying data and authorizing access to the one or more services thereto via said network access module.

2. The system as claimed in claim 1, wherein said service access module is configured to associate a service profile with the remote device based, at least in part, on said identifying data, said service profile defining access privileges for the remote device, said service access module further configured to apply said access privileges to the remote device via said network access module.

3. The system as claimed in claim 2, wherein the network access module is further configured to detect an attempt to exceed service access restrictions defined by said service profile, said network access module being configured to initiate an opportunity to upgrade said service profile when detection of the attempt to exceed said service access restrictions occurs.

4. The system as claimed in claim 1, wherein said identifying data further comprises user identification data, said service access module being configured to further authenticate the remote device or a user thereof based on said user identification data.

5. The system as claimed in claim 4, wherein said user identification data is prompted from the user via the remote device.

6. The system as claimed in claim 5, wherein said user identification data is prompted via a web browser operating on the remote device.

7. The system as claimed in claim 1, wherein the remote device is a browser-based, browserless or browser-challenged device.

8. to 9 (canceled)

10. The system as claimed in claim 2, wherein said access privileges defined by said service profile are implemented automatically by the system in authorizing to the remote device access only to network resources facilitating access to services included within said service profile.

11. (canceled)

12. The system as claimed in claim 1, wherein said service access module is further configured to confirm authentication via an SMS (Short Message Service) message between the remote device or a device associated therewith and the service access module.

13. The system as claimed in claim 1, wherein said remote device identification data is indicative of one or more of a remote device type and a MAC address of the remote device.

14 to 30. (canceled)

31. A computer-implemented method for providing a remote device wireless access to one or more services over a communication network, the method comprising the steps of:
communicating wirelessly with the remote device and receiving therefrom a wireless transmission comprising identifying data, said identifying data comprising remote device identification data automatically embedded within said wireless transmission by the remote device; and
authenticating the remote device based on said identifying data and authorizing access to the one or more services thereto.

32. The computer-implemented method as claimed in claim 31, further comprising associating a service profile with the remote device based, at least in part, on said identifying data, and applying access privileges to the remote device according to said service profile.

33. The computer-implemented method as claimed in claim 32, further comprising monitoring for attempts to exceed said access privileges and providing an opportunity to upgrade said service profile upon detecting an attempt to exceed said access privileges.

34. The computer-implemented method as claimed in claim 31, further comprising authenticating the remote device or a user thereof based on user identification data accessed from the remote device.

35. The computer-implemented method as claimed in claim 34, further comprising prompting the user via the remote device for said user identification data.

36. to 37. (canceled)

38. The computer-implemented method as claimed in claim 31, further comprising confirming authentication via SMS (Short Message Service).

39. (canceled)

40. The computer-implemented method as claimed in claim 31, wherein said remote device identification data is indicative of one or more of remote device type and a MAC address of the remote device.

41. to 53. (canceled)

54. The system as claimed in claim 1, wherein the remote device is configured to communicate a connection request to the network access module, at least a portion of said identifying data being extracted from said connection request.

55. The system as claimed in claim 1, wherein a script is configured to operate on the remote device, the script configured to transmit at least a portion of said identifying data to the network access module.

56. The system as claimed in claim 1, wherein said access authorization comprises wide-open access.

57. The system as claimed in claim 1, further configured to automatically capture and analyze said identifying data, whereby authentication is implemented automatically, at least in part, without input from the user.

58. The system as claimed in claim 4, wherein said user identification data is stored on and automatically accessed from the remote device.

59. The system as claimed in claim 1, wherein said device identification data comprises one or more inherent characteristics of the remote device automatically accessed therefrom and uniquely identifying same for authentication.

60. The system as claimed in claim 2, wherein said access privileges defined by said service profile comprise one or more authorization constraints or one or more authorization whitelists.

61. The system as claimed in claim 1, further comprising a device profile knowledge base, said service access module being further configured to cross-reference said device identification data therewith in identifying a remote device profile to be associated with the remote device for authentication.

62. The system as claimed in claim 61, said service access module being further configured to automatically associate a unique user profile with the remote device based on said device profile, and apply a service profile associated with said unique user profile defining access privileges for the remote device.

63. The system as claimed in claim 2, said service access module being further configured to associate said service profile based on one or more of device identification data, user identification data, hotspot-related data, user history, targeted marketing, promotions, user purchase history, and customer loyalty.

64. The computer-implemented method as claimed in claim 31, further comprising automatically accessing user identification data stored on the remote device for use in authentication.

65. The computer-implemented method as claimed in claim 31, further comprising operating a script on the remote device to extract therefrom at least some of said identifying data and embed same within said wireless transmission.

66. The computer-implemented method as claimed in claim 61, wherein said script is automatically transmitted to the remote device upon initiation of network access authentication.

67. The computer-implemented method as claimed in claim 31, wherein said access authorization comprises wide-open access.

68. The computer-implemented method as claimed in claim 31, wherein said device identification data comprises one or more inherent characteristics of the remote device automatically accessed therefrom and uniquely identifying same for authentication.

69. The computer-implemented method as claimed in claim 31, further comprising tailoring access toward the remote device based at least in part on said device identification data.

70. The computer-implemented method as claimed in claim 31, further comprising cross-referencing said device identification data with stored device profiles in identifying a remote device profile to be associated therewith for authentication.

71. The computer-implemented method as claimed in claim 70, further comprising associating a unique user profile with the device based on said identified remote device profile, and applying a service profile associated with said unique user profile defining access privileges for the remote device.

72. The computer-implemented method as claimed in claim 32, wherein said access privileges are based on one or more of device identification data, user identification data, hotspot-related data, user history, targeted marketing, promotions, user purchase history, and customer loyalty.

73. The computer-implemented method as claimed in claim 72, wherein said access privileges comprise free wide-open access privileges.
